(19) United States
(12) Patent Application Publication
(10) Pub. No.: US 2026/0147504 A1
(43) Pub. Date: May 28, 2026

(54) UNIVERSAL FLASH STORAGE DEVICE, UNIVERSAL FLASH STORAGE SYSTEM, AND OPERATION METHOD OF UNIVERSAL FLASH STORAGE SYSTEM

(71) Applicant: Samsung Electronics Co., Ltd., Suwon-si (KR)

(72) Inventors: Changho Seok, Suwon-si (KR); Seungyoon Yang, Suwon-si (KR); Junsob Hwang, Suwon-si (KR)

(21) Appl. No.: 19/399,099

(22) Filed: Nov. 24, 2025

(30) Foreign Application Priority Data
Nov. 25, 2024 (KR) 10-2024-0169585

(51) Int. Cl. G06F 3/06

(52) U.S. Cl. CPC G06F 3/0655; G06F 3/0604; G06F 3/0632; G06F 3/0679

(57) ABSTRACT

Universal flash storage (UFS) systems are provided. In one aspect, a UFS system includes a UFS host including a first UFS interconnect (UIC) layer and a first pin, and a UFS device including a second UIC layer configured to communicate with the first UIC layer and a second pin electrically connected to the first pin. The UFS host drives a voltage of the first pin based on first information indicating whether a high speed-link startup sequence (HS-LSS) is supported by the UFS host, and the UFS device drives a voltage of the second pin based on second information indicating whether the HS-LSS is supported by the UFS device.

### CROSS-REFERENCE TO RELATED APPLICATION(S)

This application claims priority under 35 U.S.C. § 119 to Korean Patent Application No. 10-2024-0169585 filed on Nov. 25, 2024, in the Korean Intellectual Property Office, the disclosures of which are incorporated by reference herein in their entireties.

### BACKGROUND

A semiconductor memory is classified as a volatile memory, which loses data stored therein when a power is turned off, such as a static random access memory (SRAM) or a dynamic random access memory (DRAM) or a nonvolatile memory, which retains data stored therein even when a power is turned off, such as a flash memory, a phase-change RAM (PRAM), a magnetic RAM (MRAM), a resistive RAM (RRAM), or a ferroelectric RAM (FRAM).

A flash memory device is being widely used as a high-capacity storage medium of a computing system. Nowadays, various technologies for supporting a high-speed operation of the flash memory device are being developed. As an example, a universal flash storage device defined by the JEDEC standard may support an improved operating speed compared to a conventional flash memory-based storage device.

### SUMMARY

Implementations of the present disclosure provide a universal flash storage device with reduced costs and improved reliability, a universal storage system, an operation method of the universal storage system.

According to an implementation, a universal flash storage (UFS) system includes a UFS host including a first UFS interconnect (UIC) layer and a first pin, and a UFS device including a second UIC layer configured to communicate with the first UIC layer and a second pin electrically connected to the first pin. The UFS host drives a voltage of the first pin based on first information indicating whether a high speed-link startup sequence (HS-LSS) is supported by the UFS host, and the UFS device drives a voltage of the second pin based on second information indicating whether the HS-LSS is supported by the UFS device.

According to an implementation, an operation method of a universal flash storage (UFS) system which includes a UFS host and a UFS device includes driving, by the UFS host, a voltage of a first pin based on first information and driving, by the UFS device, a voltage of a second pin electrically connected to the first pin based on second information, in a reset operation of the UFS system, determining, by each of the UFS host and the UFS device, a link startup mode based on a connecting voltage of the first and second pins, and performing a link startup sequence (LSS) operation on a first UFS interconnect (UIC) layer of the UFS host and a second UIC layer of the UFS device, based on the determined link startup mode. The first information indicates whether a high speed-LSS (HS-LSS) is supported by the UFS host, and the second information indicates whether the HS-LSS is supported by the UFS device.

According to an implementation, a universal flash storage (UFS) device includes a UFS interconnect (UIC) layer that communicates with an external UFS host, a nonvolatile memory, a UFS device controller that controls the nonvolatile memory based on a command received from the UIC layer, and a link startup mode circuit that drives a first pin with a power supply voltage when a high speed-link startup sequence (HS-LSS) for the UIC layer is supported and drives the first pin with a ground voltage when the HS-LSS for the UIC layer is not supported. The first pin is electrically connected to the UFS host. In a reset operation on the UFS device, the link startup mode circuit selects one of the HS-LSS and a low speed-LSS (LS-LSS) based on a voltage of the first pin. The UIC layer performs a link startup sequence operation with the external UFS host based on the one selected from the HS-LSS and the LS-LSS.

According to an implementation, a universal flash storage (UFS) host includes a UFS interconnect (UIC) layer that communicates with an external UFS device, a UFS host controller that exchanges a UFS protocol information unit (UPIU) with the external UFS device through the UIC layer, and a link startup mode circuit that drives a first pin with a power supply voltage when a high speed-link startup sequence (HS-LSS) for the UIC layer is supported and drives the first pin with a ground voltage when the HS-LSS for the UIC layer is not supported. The first pin is electrically connected to the UFS device.

According to an implementation, a universal flash storage (UFS) host includes a UFS interconnect (UIC) layer that communicates with an external UFS device, a UFS host controller that exchanges a UFS protocol information unit (UPIU) with the external UFS device through the UIC layer, and a link startup mode circuit that receives a first setting signal from the external UFS device and selects a link startup mode based on the first setting signal and a second setting signal. The first setting signal indicates whether a high speed-link startup sequence (HS-LSS) is supported by the UFS device, and the second setting signal indicates whether the HS-LSS is supported by the UFS host.

According to an implementation, a universal flash storage (UFS) device includes a UFS interconnect (UIC) layer that communicates with an external UFS host, a nonvolatile memory, a UFS device controller that controls the nonvolatile memory based on a command received from the UIC layer, and a link startup mode circuit that receives a first setting signal from the external UFS host and selects a link startup mode based on the first setting signal and a second setting signal. The first setting signal indicates whether a high speed-link startup sequence (HS-LSS) is supported by the UFS device, and the second setting signal indicates whether the HS-LSS is supported by the UFS host.

### BRIEF DESCRIPTION OF THE FIGURES

The above and other objects and features of the present disclosure will become apparent by describing in detail implementations thereof with reference to the accompanying drawings.

FIG. 1 is a block diagram illustrating a universal flash storage (UFS) system according to an implementation of the present disclosure.

FIG. 2 is a diagram a diagram illustrating a hierarchical structure of a UFS system of FIG. 1.

FIG. 3 is a diagram for describing an example of setting a link startup mode of a UFS system of FIG. 1.

FIG. 4 is a flowchart illustrating an operation of a UFS system of FIG. 1.

FIG. 5 is a block diagram illustrating a first link startup mode circuit and a second link startup mode circuit of FIG. 1.

FIGS. 6A to 6C are circuit diagrams for illustrating a first link startup mode circuit and a second link startup mode circuit of FIG. 5.

FIG. 7 is a circuit diagram illustrating a first link startup mode circuit and a second link startup mode circuit of FIG. 5.

FIG. 8 is a block diagram illustrating a UFS system according to an implementation of the present disclosure.

FIG. 9 is a flowchart illustrating an example of an operation of a UFS system of FIG. 8.

FIG. 10 is a diagram for illustrating first and second link startup mode circuits of FIG. 8.

FIG. 11 is a block diagram illustrating a UFS system according to an implementation of the present disclosure.

FIG. 12 is a flowchart illustrating an operation of a UFS system of FIG. 11.

FIG. 13 is a diagram illustrating first and second link startup mode circuits of FIG. 11.

FIG. 14 is a block diagram illustrating a UFS system according to an implementation of the present disclosure.

FIG. 15 is a flowchart illustrating an operation of a UFS system of FIG. 14.

FIG. 16 is a block diagram illustrating a UFS system according to an implementation of the present disclosure.

FIG. 17 is a flowchart illustrating an operation of a UFS system of FIG. 16.

FIGS. 18A to 18C are diagrams for illustrating an example of a form factor of a UFS card.

FIG. 19 is a block diagram illustrating a system according to an implementation of the present disclosure.

FIG. 20 is a diagram illustrating a system to which a storage device according to an implementation of the present disclosure is applied.

### DETAILED DESCRIPTION

Below, implementations of the present disclosure will be described in detail and clearly to such an extent that an ordinary one in the art easily carries out the present disclosure.

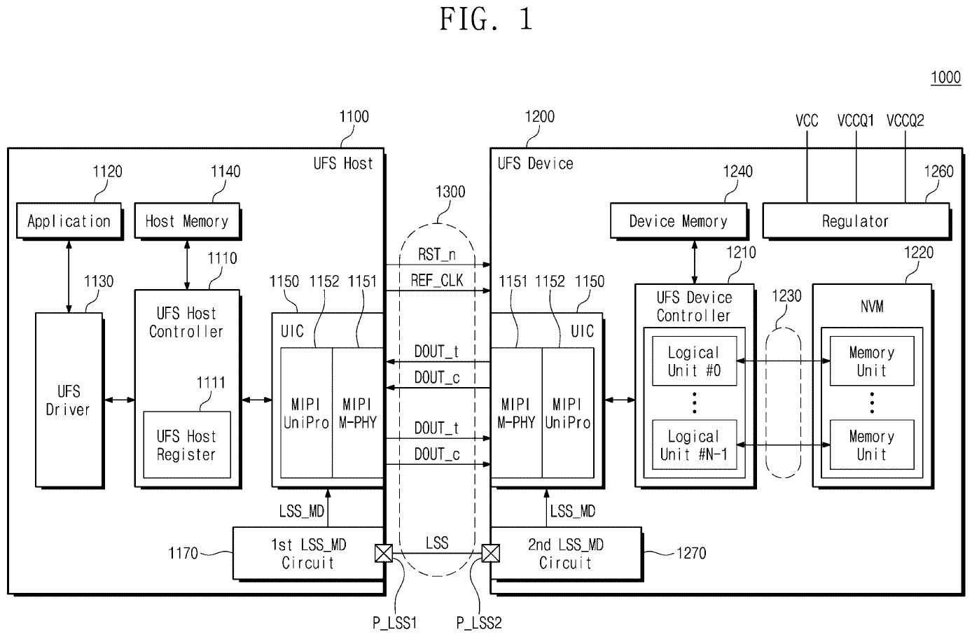

FIG. 1 is a block diagram illustrating a universal flash storage (UFS) system according to an implementation of the present disclosure. Referring to FIG. 1, a UFS system 1000 may be a system complying with a universal flash storage (UFS) standard announced by the JEDEC (Joint Electron Device Engineering Council). However, the present disclosure is not limited thereto. For example, the UFS system 100 may include at least one of various types of storage systems such as an NVMe-based SSD, an MMC, an eMMC, and an SD card.

The UFS system 1000 may include a UFS host 1100 and a UFS device 1200. The UFS host 1100 may be connected to the UFS device 1200 through an UFS interface 1300. In an implementation, the UFS host 1100 may be implemented in the form of an intellectual property (IP) block included in a central processing unit (CPU) or an application processor (AP), hardware, software, or firmware, or in the form of a combination thereof.

The UFS host 1100 may include a UFS host controller 1110, an application 1120, a UFS driver 1130, a UFS interconnect (UIC) layer 1150, and a first link startup mode circuit 1170.

The application 1120 may include a program configured to communicate with the UFS device 1200 to use or control a function of the UFS device 1200. In an implementation, the application 1120 may be stored in a host memory 1140. The application 1120 may transmit an input-output request IOR to the UFS driver 1130 for input/output (I/O) operations on the UFS device 1200. The input-output request IOR may refer to a data read request, a data storage (or write) request, and/or a data erase (or discard) request, but the present disclosure is not limited thereto.

The UFS driver 1130 may be configured to control or manage the UFS host controller 1110 through a UFS-host controller interface (UFS-HCI). The UFS driver 1130 may convert the input-output request generated by the application 1120 into a UFS command defined by the UFS standard and may transmit the UFS command to the UFS host controller 1110. In an implementation, one input-output request may be converted into a plurality of UFS commands. In an implementation, the UFS command may refer to a command defined by the SCSI (Small Computer System Interface) standard or a command dedicated to the UFS standard.

The UFS host controller 1110 may transmit the UFS command converted by the UFS driver 1130 to the UFS device 1200 through the UIC layer 1150 and the UFS interface 1300. For example, the UFS host controller 1110 may generate a packet of a UPIU (UFS Protocol Information Unit) based on the UFS command. The UFS host controller 1110 may transmit the UPIU packet to the UIC layer 1150. In an implementation, the UFS host controller 1110 may operate based on information stored in the host memory 1140.

In an implementation, a UFS host register 1111 of the UFS host controller 1110 may perform a role of a command queue (CQ). For example, the UFS host 1100 may store commands to be transmitted to the UFS device 1200 in the UFS host register 1111 capable of functioning as the command queue depending on the order and may transmit the stored commands to the UFS device 1200 in a “COMMAND UPIU” form depending on the order. In this case, even in the case where the previously transmitted command is being still processed by the UFS device 1200, that is, even before the UFS host 1100 receives the notification that the previously transmitted command is completely processed by the UFS device 1200, the UFS host 1100 may transmit a next command pending in the command queue to the UFS device 1200, and thus, the UFS device 1200 may also receive the next command from the UFS host 1100 even while processing the previously transmitted command. The maximum number of commands capable of being stored in the command queue, that is, the queue depth of the command queue may be, for example, 32. Also, the command queue may be implemented as a circular queue in which a start and an end of a command line stored in a queue are indicated by a head pointer and a tail pointer. However, the present disclosure is not limited thereto.

The UIC layer 1150 of the UFS host 1100 may include a physical layer configured to transmit the UPIU packet including the UFS command to the UFS device 1200 or to receive the UPIU packet including information or data from the UFS device 1200. In an implementation, the physical layer may include an MIPI M-PHY 1251 and an MIPI UniPro 1252.

The UFS interface 1300 may include a line configured to transmit a reference clock signal REF_CLK, a line configured to transmit a hardware reset signal RESET_n for the UFS device 1200, a pair of lines configured to transmit a pair of differential input signals DIN_t and DIN_c, and a pair of lines configured to transmit a pair of differential output signals DOUT_t and DOUT_c. In an implementation, the UFS interface 1300 may include a link startup sequence (LSS) line configured to transmit/receive a signal or information for setting an LSS mode.

A frequency of the reference clock signal REF_CLK provided from the UFS host 1100 to the UFS device 1200 may be one of 19.2 MHZ, 26 MHz, 38.4 MHZ, and 52 MHz, but the present disclosure is not limited thereto. The UFS host 1100 may change the frequency of the reference clock signal REF_CLK during an operation, that is, during data transmission/reception operations between the UFS host 1100 and the UFS device 1200. The UFS device 1200 may generate clocks having various frequencies from the reference clock signal REF_CLK provided from the UFS host 1100 by using a phase-locked loop (PLL) or the like. The UFS host 1100 may set a data rate between the UFS host 1100 and the UFS device 1200 by using the frequency of the reference clock signal REF_CLK. That is, the data rate may be determined depending on the frequency of the reference clock signal REF_CLK.

The UFS interface 2300 may support multiple lanes, each of which may be implemented as a pair of differential lines. For example, the UFS interface 1300 may include at least one receive lane and at least one transmit lane. In FIG. 1, a pair of lines configured to transmit a pair of differential input signals DIN_T and DIN_C may constitute the receive lane, and a pair of lines configured to transmit a pair of differential output signals DOUT_T and DOUT_C may constitute the transmit lane. Even though one transmit lane and one receive lane are illustrated in FIG. 1, the number of transmit lanes and the number of receive lanes may be changed.

The receive lane and the transmit lane may transmit data based on a serial communication scheme, and full-duplex communications between the UFS host 1100 and the UFS device 1200 may be enabled due to a structure in which the receive lane is separated from the transmit lane. For example, even while receiving data from the UFS host 1100 through the receive lane, the UFS device 1200 may transmit data to the UFS host 1100 through the transmit lane. Control data (e.g., a command) from the UFS host 1100 to the UFS device 1200, write data to be stored in the UFS device 1200, and read data read from the UFS device 1200 may be transmitted through the same lane. Accordingly, between the UFS host 1100 and the UFS device 1200, there may be no need to further provide a separate lane for data transmission in addition to a pair of receive lanes and a pair of transmit lanes.

The UFS device 1200 may include a UFS device controller 1210, a nonvolatile memory 1220, a nonvolatile memory interface 1230, a device memory 1240, a UIC layer 1250, a regulator 1260, and a second link startup mode circuit 1270.

The UFS device controller 1210 may control all operations of the UFS device 1200. The UFS device controller 1210 may control the nonvolatile memory 1220 by using a logical unit (LU) being logical data storage unit. In an implementation, the number of LUs may be eight, but the present disclosure is not limited thereto. In an implementation, the UFS device controller 1210 may control the nonvolatile memory 1220 through the nonvolatile memory interface 1230. The nonvolatile memory interface 1230 may be implemented to comply with the standard protocol such as Toggle or ONFI.

The UFS device controller 1210 may include a flash translation layer (FTL). The UFS device controller 1210 may convert a logical data address (e.g., a logical block address (LBA)) transmitted from the UFS host 1100 into a physical data address (e.g., a physical block address (PBA)) by using address mapping information of the FTL. A logical block configured to store user data in the UFS system 1000 may have a size in a given range. For example, a minimum size of the logical block may be set to 4 Kbyte.

The nonvolatile memory 1220 may include a plurality of memory units, each of which may include a NAND flash memory of a two-dimensional (2D) structure or a V-NAND flash memory of a three-dimensional (3D) structure. However, the present disclosure is not limited thereto. For example, each of the plurality of memory units may include different kinds of nonvolatile memories such as a MRAM, a PRAM, or a RRAM.

Each of the plurality of memory units may include a memory cell array (not illustrated) and a control circuit (not illustrated) configured to control an operation of the memory cell array. The memory cell array may include a 2D memory cell array or a 3D memory cell array. The memory cell array may include a plurality of memory cells. Even though each of the memory cells is a single level cell (SLC) configured to store one-bit information, each of the memory cells may be a cell configured to store information of two bits or more, such as a multi-level cell (MLC), a triple level cell (TLC), and a quadruple level cell (QLC). The 3D memory cell array may include a vertical NAND string in which at least one memory cell is vertically oriented and located on another memory cell.

The UIC layer 1250 of the UFS device 1200 may receive the UPIU including the UFS command from the UFS host 1100. The UFS device 1210 may perform an operation corresponding to the UFS command included in the received UPIU. After completing the operation, the UFS device controller 1210 may transmit the UPIU including a completion response to the UFS host 1100 through the UIC layer 1250.

As an example, the UFS host 1100 may store user data in the UFS device 1200. In this case, the UFS host 1100 may transmit a command UPIU including a data storage command to the UFS device 1200. The UFS device 1200 may transmit a “ready-to-transfer” (RTT) UPIU to the UFS host 1100 in response to the data storage command included in the command UPIU. The UFS host 1100 may transmit the DATA OUT UPIU including the user data to the UFS device 1200 in response to the RTT UPIU. The UFS device 1200 may temporarily store the user data included in the DATA OUT UPIU in the device memory 1240. The UFS device 1200 may store the temporarily stored user data in the nonvolatile memory 1220, based on the address mapping information of the FTL.

As an example, the UFS host 1100 may read the user data from the UFS device 1200. In this case, the UFS host 1100 may transmit a command UPIU including a data read command to the UFS device 1200. In response to the data read command included in the command UPIU, the UFS device 1200 may read the user data from the nonvolatile memory 1220 and may temporarily store the read user data in the device memory 1240. The UFS device 1200 may transmit the DATA IN UPIU including the user data temporarily stored in the device memory 1240 to the UFS host 1100.

In an implementation, the UFS device 1210 may include an error correction code (ECC) engine. The UFS device controller 1210 may correct an error of the user data read from the nonvolatile memory 1220 by using the ECC engine. In an implementation, the UFS device controller 1210 may include an advanced encryption standard (AES) engine. The AES engine of the UFS device controller 1210 may perform at least one of an encryption operation and a decryption operation on the received data by using a symmetric-key algorithm.

The UFS device 1200 may receive various power supply voltages (e.g., VCC, VCCQ, and VCCQ2). The power supply voltage VCC which is a main power supply voltage for the UFS device 1200 may be in a range of 2.4 V to 3.6 V. The power supply voltage VCCQ which is a power supply voltage for supplying a voltage in a low range may be mainly used for the UFS device controller 1210 and may be may be in a range of 1.14 V to 1.26 V. The power supply voltage VCCQ2 which is a power supply voltage for supplying a voltage in a higher range than the power supply voltage VCCQ may be mainly used for an input/output interface such as the MIPI M-PHY 1251 and may be in a range of 1.7 V to 1.95 V. The power supply voltages VCC, VCCQ, and VCCQ2 may be supplied to components of the UFS device 1200 through the regulator 1260. The regulator 1260 may be implemented as a set of unit regulators respectively connected to different ones of the power supply voltages VCC, VCCQ, and VCCQ2 described above.

In an implementation, the UFS system 1000 may perform an initialization operation under various conditions. For example, the UFS system 1000 may perform the initialization operation in a power-on reset, a hardware reset, or an endpoint reset. After the initialization operation is normally performed, the UFS host 1100 and the UFS device 1200 may perform the normal operation.

In an implementation, in the initialization operation of the UFS system 1000, a link startup sequence (LSS) for initiating the communications between physical layers of the UFS host 1100 and the UFS device 1200 may be performed. For example, the UIC layer 1150 of the UFS host 1100 and the UIC layer 1250 of the UFS device 1200 may exchange a UniPro trigger event and may perform an LSS operation implementing an initial link communication.

In an implementation, the LSS operation may be performed based on various operation modes. For example, the LSS operation may be performed based on link startup sequence modes. In an implementation, the link startup sequence modes may include a high speed-LSS (HS-LSS) or a low speed-LSS (LS-LSS). In the HS-LSS, the LSS operation may be performed based on a clock frequency of the HS-G1 speed gear defined by the UFS standard; in the LS-LSS, the LSS operation may be performed based on a clock frequency of the PWM-G1 speed gear defined by the UFS standard. That is, the HS-LSS may support a faster LSS operation than the LS-LSS.

Link startup modes which are respectively supported by the UFS host 1100 and the UFS device 1200 may be different from each other. When the link startup modes of the UFS host 1100 and the UFS device 1200 are differently set, the UFS host 1100 and the UFS device 1200 are incapable of performing the LSS operation normally.

According to an implementation of the present disclosure, without external intervention or control, the link startup modes of the UFS host 1100 and the UFS device 1200 may be identically set. For example, the UFS host 1100 may include the first link startup mode circuit 1170, and the UFS device 1200 may include the second link startup mode circuit 1270. The first link startup mode circuit 1170 and the second link startup mode circuit 1270 may be electrically connected through the LSS line.

The first link startup mode circuit 1170 may control a level of the LSS line, based on the link startup mode supported by the UFS host 1100. The second link startup mode circuit 1270 may control a level of the LSS line, based on the link startup mode supported by the UFS device 1200. In this case, the voltage level of the LSS line may be determined based on the link startup mode supported by the UFS host 1100 and the link startup mode supported by the UFS device 1200. For example, when the HS-LSS and the LS-LSS are supported by the UFS host 1100 and the HS-LSS and the LS-LSS are supported by the UFS device 1200, the LSS line may be determined to be set to a first voltage. Alternatively, when the HS-LSS and the LS-LSS are supported by the UFS host 1100 and only the LS-LSS is supported by the UFS device 1200, the LSS line may be determined to be set to a second voltage lower than the first voltage. Alternatively, when only the LS-LSS is supported by the UFS host 1100 and only the LS-LSS is supported by the UFS device 1200, the LSS line may be determined to be set to a third voltage lower than the second voltage.

The first link startup mode circuit 1170 may determine a link startup mode LSS_MD of the UFS host 1100 based on the voltage of the LSS line, and the second link startup mode circuit 1270 may determine the link startup mode LSS_MD of the UFS device 1200 based on the voltage of the LSS line. For example, when the LSS line is set to the first voltage, the link startup mode LSS_MD of each of the UFS host 1100 and the UFS device 1200 may be determined as the HS-LSS. When the LSS line is set to the second voltage lower than the first voltage, the link startup mode LSS_MD of each of the UFS host 1100 and the UFS device 1200 may be determined as the LS-LSS. When the LSS line is set to the third voltage lower than the second voltage, the link startup mode LSS_MD of each of the UFS host 1100 and the UFS device 1200 may be determined as the LS-LSS. That is, because the link startup modes of the UFS host 1100 and the UFS device 1200 are determined such that both the link startup mode supported by the UFS host 1100 and the link startup mode supported by the UFS device 1200 are satisfied, the LSS operation of the UFS system 1000 may be normally performed.

In an implementation, each of the UFS host 1100 and the UFS device 1200 may support the LS-LSS necessarily or mandatorily and may support the HS-LSS optionally. That is, when both the UFS host 1100 and the UFS device 1200 support the HS-LSS, the UFS host 1100 and the UFS device 1200 may perform a link startup sequence operation based on the HS-LSS. In contrast, when at least one of the UFS host 1100 and the UFS device 1200 does not support the HS-LSS, the UFS host 1100 and the UFS device 1200 should perform the link startup sequence operation based on the LS-LSS.

Operations and structures of the first link startup mode circuit 1170 and the second link startup mode circuit 1270 according to an implementation of the present disclosure will be described in detail with reference to the following drawings.

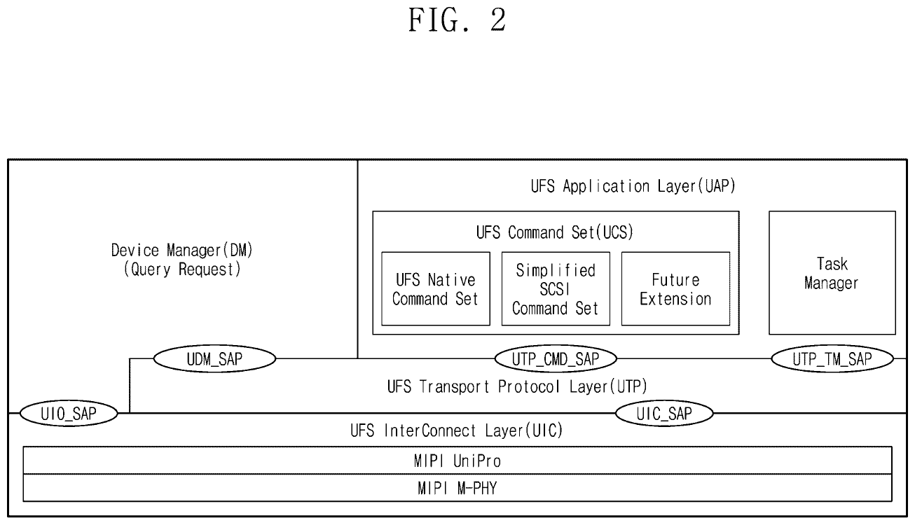

FIG. 2 is a diagram a diagram illustrating a hierarchical structure of a UFS system of FIG. 1. For convenience, the hierarchical structure of FIG. 2 will be described based on the UFS device 1200 of FIG. 1. However, the present disclosure is not limited thereto. For example, the UFS host 1100 of FIG. 1 may include a structure similar to the hierarchical structure of FIG. 2.

Referring to FIGS. 1 and 2, the UFS device 1200 may include a UFS application layer UAP, a UFS transport protocol layer UTP, a UFS interconnect layer UIC, and a device manager DM.

The UFS application layer UAP may include various application programs, various processes, etc. which are driven in the UFS device 1200. The UFS application layer UAP is configured to support various commands between the UFS host 1100 and the UFS device 1200. For example, the UFS application layer UAP may include a UFS command set UCS. The UFS command set UCS may include a UFS negative command set, a simplified SCSI command set, and a future extension command. The UFS application layer UAP may include a task manager configured to manage a command and a command queue control.

The device manager DM may manage operations of a device level and components of a device level. In an implementation, the device manager DM may manage a query request for setting or checking various information of the UFS device 1200.

The UFS transport protocol layer UTP may provide services for an upper layer. The UFS transport protocol layer UTP may generate a packet of the UPIU (UFS Protocol Information Unit) format based on the command or information provided from the UFS application layer UAP or the query request provided from the device manager DM. In an implementation, the UFS transport protocol layer UTP and the device manager DM may communicate with each other through the UDM-SAP (UDM-Service Access Point). A UFS transport protocol layer UTP and a UFS application layer UAP may communicate with each other through the UTP_CMD_SAP or UTP_TM_SAP.

The UFS interconnect layer UIC may manage a physical connection between the UFS host 1100 and the UFS device 1200. In an implementation, the UFS interconnect layer UIC may include physical layers or hardware components such as MIPI Unipro and MIPI M-PHY. In an implementation, the physical layers or hardware components of the UFS interconnect layer UIC of the UFS device 1200, such as MIPI Unipro and MIPI M-PHY, may be physically connected to the physical layers or hardware components of the UFS interconnect layer UIC of the UFS host 1100, such as MIPI Unipro and MIPI M-PHY.

The UFS interconnect layer UIC and the UFS transport protocol layer UTP may communicate through the UIC-SAP, and the UFS interconnect layer UIC and the device manager DM may communicate through the UIO-SAP.

In an implementation, in the initialization operation of the UFS system 1000, the LSS operation on the UIC layer 1250 may be initiated by using the DME_LINKSTARTUP.req primitive corresponding to the UIO-SAP.

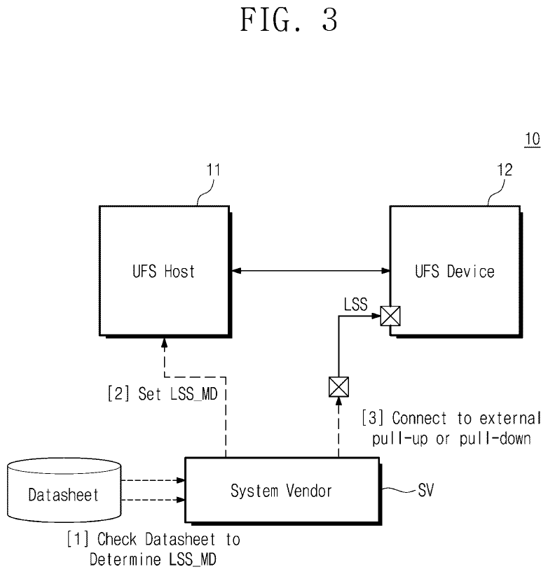

FIG. 3 is a diagram for describing an example of setting a link startup mode of a UFS system of FIG. 1. Referring to FIG. 3, a UFS system 10 may include a UFS host 11 and a UFS device 12. In an implementation, it is assumed that the UFS system 10 is included in a mobile system such as a smartphone, a tablet, or a laptop. In this case, a system vendor SV which manufactures the mobile system may manufacture the mobile system including the UFS host 11 and the UFS device 12. In this case, the system vendor SV may check a data sheet of each of the UFS host 11 and the UFS device 12 and may determine the link startup mode LSS_MD (step [1] of FIG. 3). For example, each of the UFS host 11 and the UFS device 12 may be manufactured by an individual vendor, and the link startup modes LSS_MD supported by the UFS host 11 and the UFS device 12 may be different from each other. The system vendor SV may check the link startup mode supported by the UFS host 11 through the data sheet of the UFS host 11 and may check the link startup mode supported by the UFS device 12 through the data sheet of the UFS device 12. When both the UFS host 11 and the UFS device 12 support the HS-LSS, the system vendor SV may determine the link startup mode LSS_MD of each of the UFS host 11 and the UFS device 12 as the HS-LSS. When at least one of the UFS host 11 and the UFS device 12 does not support the HS-LSS, the system vendor SV may determine the link startup mode LSS_MD of each of the UFS host 11 and the UFS device 12 as the LS-LSS.

The system vendor SV may set the link startup mode LSS_MD of the UFS host 11, based on the determined link startup mode LSS_MD (step [2] of FIG. 3). For example, the system vendor SV may set information corresponding to the determined link startup mode LSS_MD to the UFS host 11. The UFS host 11 may perform the LSS operation in the link startup mode LSS_MD corresponding to the set information.

The system vendor SV may connect or terminate the LSS line or LSS pin of the UFS device 12 to or from an external pull-up or an external pull-down based on the determined link startup mode LSS_MD (step [3] of FIG. 3). For example, when the determined link startup mode LSS_MD corresponds to the HS-LSS, the system vendor SV may connect the LSS line or LSS pin of the UFS device 12 to the external pull-up (e.g., a pull-up terminal of a system board). Alternatively, when the determined link startup mode LSS_MD corresponds to the LS-LSS, the system vendor SV may connect the LSS line or LSS pin of the UFS device 12 to the external pull-down (e.g., a pull-down terminal of the system board). The UFS device 12 may perform the LSS operation in the link startup mode LSS_MD corresponding to a level of the LSS line.

As described with reference to FIG. 3, the link startup mode LSS_MD supported by the UFS host 11 may be different from the link startup mode LSS_MD supported by the UFS device 12. Accordingly, the system vendor SV which uses the UFS host 11 and the UFS device 12 should separately check the data sheets of the UFS host 11 and the UFS device 12 and should individually set the link startup modes LSS_MD of the UFS host 11 and the UFS device 12. This acts as the burden of the system manufacturing process.

According to an implementation of the present disclosure, each of the UFS host 1100 and the UFS device 1200 may control the voltage of the LSS line based on the link startup mode LSS_MD supported thereby, and the link startup mode LSS_MD capable of being executed by each of the UFS host 1100 and the UFS device 1200 may be determined based on the voltage of the LSS line. In this case, even though the system vendor SV does not separately check the link startup mode LSS_MD through the data sheets of the UFS host 1100 and the UFS device 1200, an operation of setting the link startup mode LSS_MD for each of the UFS host 1100 and the UFS device 1200 may be omitted.

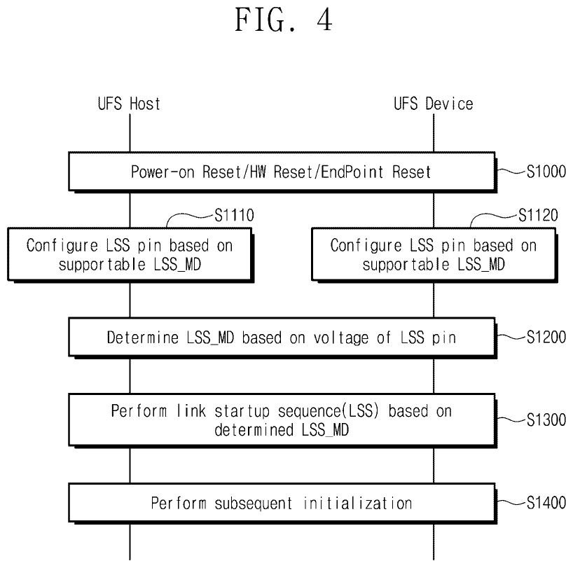

FIG. 4 is a flowchart illustrating an operation of a UFS system of FIG. 1. Referring to FIGS. 1 and 4, in operation S1000, the UFS system 1000 may perform a reset. For example, the UFS system 1000 may perform a reset operation such as a power-on reset, a hardware reset, or an endpoint reset. In an implementation, in the reset operation, the UFS host 1100 may transmit a reset signal RST_n to the UFS device 1200 through a reset line.

In operation S1110, the UFS host 1100 may configure the LSS pin, based on the supportable link startup mode LSS_MD. For example, when the UFS host 1100 supports the HS-LSS and the LS-LSS, the first link startup mode circuit 1170 of the UFS host 1100 may drive the LSS line with a power supply voltage by using a pull-up driver. Alternatively, when the UFS host 1100 supports only the LS-LSS, the first link startup mode circuit 1170 of the UFS host 1100 may drive the LSS line with a ground voltage by using a pull-down driver.

In operation S1120, the UFS device 1200 may configure the LSS pin based on the supportable link startup mode LSS_MD. For example, when the UFS device 1200 supports the HS-LSS and the LS-LSS, the second link startup mode circuit 1270 of the UFS device 1200 may drive the LSS line with the power supply voltage by using a pull-up driver. Alternatively, when the UFS device 1200 supports only the LS-LSS, the second link startup mode circuit 1270 of the UFS device 1200 may drive the LSS line with the ground voltage by using a pull-down driver.

In an implementation, operation S1110 and operation S1120 may be performed simultaneously or in parallel in response to the reset signal RST_n. In an implementation, operation S1110 and operation S1120 may be performed based on information (i.e., information about the supportable link startup mode LSS_MD) set in advance in each of the UFS host 1100 and the UFS device 1200 without external intervention (e.g., individual setting of a system vendor).

In operation S1200, the UFS system 1000 may determine the link startup mode LSS_MD based on the voltage of the LSS line. For example, the LSS line may be controlled or driven by each of the first link startup mode circuit 1170 of the UFS host 1100 and the second link startup mode circuit 1270 of the UFS device 1200. That is, the final voltage of the LSS line may be determined. As an example, when both the UFS host 1100 and the UFS device 1200 support the HS-LSS and the LS-LSS, the LSS line may be determined to be set to the first voltage. In this case, the first link startup mode circuit 1170 and the second link startup mode circuit 1270 may determine the link startup mode LSS_MD as the HS-LSS. Alternatively, when at least one of the UFS host 1100 and the UFS device 1200 supports the LS-LSS, the LSS line may be determined to be set to the second voltage lower than the first voltage. In this case, the first link startup mode circuit 1170 and the second link startup mode circuit 1270 may determine the link startup mode LSS_MD as the LS-LSS. Alternatively, when both the UFS host 1100 and the UFS device 1200 support only the LS-LSS, the LSS line may be determined to be set to the third voltage lower than the second voltage. In this case, the first link startup mode circuit 1170 and the second link startup mode circuit 1270 may determine the link startup mode LSS_MD as the LS-LSS. That is, the link startup mode LSS_MD which is supported by both the UFS host 1100 and the UFS device 1200 may be determined based on the voltage of the LSS line.

In operation S1300, the UFS system 1000 may perform the LSS operation based on the determined link startup mode LSS_MD. For example, when the determined link startup mode LSS_MD corresponds to the HS-LSS, the UIC layer 1150 of the UFS host 1100 and the UIC layer 1250 of the UFS device 1200 may perform the initialization or LSS operation based on the clock frequency of the HS-G1 speed gear. For example, when the determined link startup mode LSS_MD corresponds to the LS-LSS, the UIC layer 1150 of the UFS host 1100 and the UIC layer 1250 of the UFS device 1200 may perform the initialization or LSS operation based on the clock frequency of the PWM-G1 speed gear.

In operation S1400, the UFS system 1000 may perform a subsequent initialization operation. For example, the UFS host 1100 and the UFS device 1200 of the UFS system 1000 may perform an operation such as UTP layer initialization, UAP layer initialization, or device initialization completion.

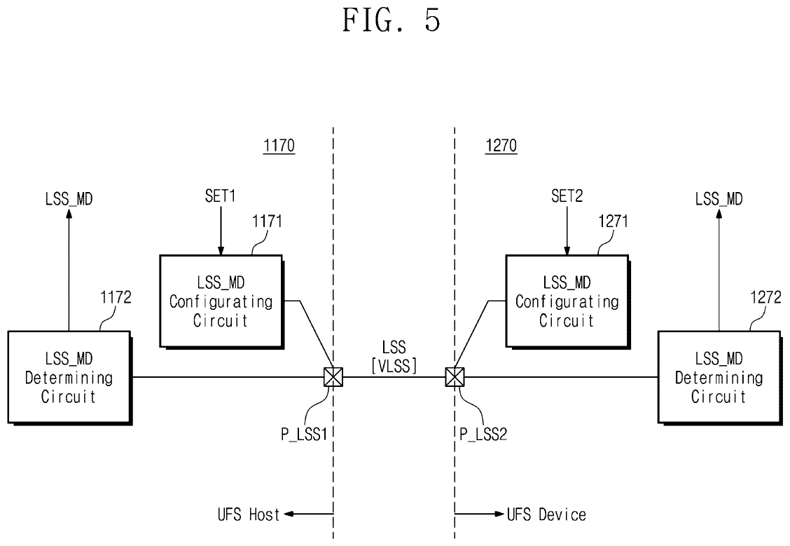

FIG. 5 is a block diagram illustrating a first link startup mode circuit and a second link startup mode circuit of FIG. 1. For convenience of description, components which are unnecessary to set or determine the link startup mode are omitted.

Referring to FIGS. 1 and 5, the first link startup mode circuit 1170 may include a first link startup mode configuring circuit 1171 and a first link startup mode determining circuit 1172. The second link startup mode circuit 1270 may include a second link startup mode configuring circuit 1271 and a second link startup mode determining circuit 1272.

The first link startup mode configuring circuit 1171 may be connected to a first LSS pin P_LSS1. The first link startup mode configuring circuit 1171 may control or drive a voltage level of the first LSS pin P_LSS1 in response to a first setting signal SET1. For example, the first setting signal SET1 may be set in advance based on the link startup mode LSS_MD supportable by the UFS host 1100. When the HS-LSS and the LS-LSS are supported by the UFS host 1100, a first pull-up driver of the first link startup mode configuring circuit 1171 may be activated in response to the first setting signal SET1, and thus, the first LSS pin P_LSS1 may be driven with the power supply voltage. When only the LS-LSS is supported by the UFS host 1100 or the HS-LSS is not supported by the UFS host 1100, a first pull-down driver of the first link startup mode configuring circuit 1171 may be activated in response to the first setting signal SET1, and thus, the first LSS pin P_LSS1 may be driven with the ground voltage.

The second link startup mode configuring circuit 1271 may be connected to a second LSS pin P_LSS2. The second link startup mode configuring circuit 1271 may control or drive a voltage level of the second LSS pin P_LSS2 in response to a second setting signal SET2. For example, the second setting signal SET2 may be set in advance based on the link startup mode LSS_MD supportable by the UFS device 1200. When the HS-LSS and the LS-LSS are supported by the UFS device 1200, a second pull-up driver of the second link startup mode configuring circuit 1271 may be activated in response to the second setting signal SET2, and thus, the second LSS pin P_LSS2 may be driven with the power supply voltage. When only the LS-LSS is supported by the UFS device 1200 or the HS-LSS is not supported by the UFS device 1200, a second pull-down driver of the second link startup mode configuring circuit 1271 may be activated in response to the second setting signal SET2, and thus, the second LSS pin P_LSS2 may be driven with the ground voltage.

The first and second LSS pins P_LSS1 and P_LSS2 may be electrically connected to each other through the LSS line. That is, a connecting voltage VLSS of the LSS line may be determined by the operations of the first and second link startup mode configuring circuits 1171 and 1271. In an implementation, the driving capability of the first and second pull-down drivers may be greater than the driving capability of the first and second pull-up drivers. For convenience of description, it is assumed that the driving capability of the first and second pull-down drivers are three times the driving capability of the first and second pull-up drivers.

In this case, when the HS-LSS and the LS-LSS are supported by the UFS host 1100 and the UFS device 1200, the first pull-up driver of the first link startup mode configuring circuit 1171 and the second pull-up driver of the second link startup mode configuring circuit 1271 are activated. In this case, because the LSS line is connected to the first and second pull-up drivers, the connecting voltage VLSS of the LSS line may be the power supply voltage.

Alternatively, when the HS-LSS and the LS-LSS are supported by the UFS host 1100 and only the LS-LSS is supported by the UFS device 1200, the first pull-up driver of the first link startup mode configuring circuit 1171 and the second pull-down driver of the second link startup mode configuring circuit 1271 are activated. In this case, the LSS line is connected to the first pull-up driver and the second pull-down driver. As described above, because the driving capability of the second pull-down driver is three times the driving capability of the first pull-up driver, the connecting voltage VLSS of the LSS line may be ¼ times the power supply voltage.

Alternatively, when only the LS-LSS is supported by the UFS host 1100 and the UFS device 1200, the first pull-down driver of the first link startup mode configuring circuit 1171 and the second pull-down driver of the second link startup mode configuring circuit 1271 are activated. In this case, because the LSS line is connected to the first and second pull-down drivers, the connecting voltage VLSS of the LSS line may be the ground voltage.

The first link startup mode determining circuit 1172 may be connected to the LSS line through the first LSS pin P_LSS1 and may determine the link startup mode LSS_MD based on the connecting voltage VLSS of the LSS line. For example, as described above, depending on the link startup mode LSS_MD supported by the UFS host 1100 and the UFS device 1200, the connecting voltage VLSS of the LSS line may have the power supply voltage, ¼ times the power supply voltage, or the ground voltage. When the connecting voltage VLSS of the LSS line is greater than a reference voltage (e.g., when the connecting voltage VLSS is the power supply voltage), the first link startup mode determining circuit 1172 may determine the link startup mode LSS_MD as the HS-LSS. When the connecting voltage VLSS of the LSS line is smaller than the reference voltage (e.g., when the connecting voltage VLSS is ¼ times the power supply voltage or the ground voltage), the first link startup mode determining circuit 1172 may determine the link startup mode LSS_MD as the LS-LSS.

The second link startup mode determining circuit 1272 may be connected to the LSS line through the second LSS pin P_LSS2 and may determine the link startup mode LSS_MD based on the connecting voltage VLSS of the LSS line. An operation of the second link startup mode determining circuit 1272 is similar to the first link startup mode determining circuit 1172 except that the second link startup mode determining circuit 1272 is placed on a UFS device (1200) side, and thus, additional description will be omitted to avoid redundancy.

In an implementation, the description is given as the first and second link startup mode configuring circuit 1171 and 1271 include the pull-up driver and the pull-down driver, but the present disclosure is not limited thereto. For example, the first link startup mode configuring circuit 1171 may include a driver configured to drive the first LSS pin P_LSS1 based on the link startup mode LSS_MD supported by the UFS host 1100. The second link startup mode configuring circuit 1271 may include a driver configured to drive the second LSS pin P_LSS2 based on the link startup mode LSS_MD supported by the UFS device 1200. The drivers of the first and second link startup mode configuring circuits 1171 and 1271 may be implemented in various forms.

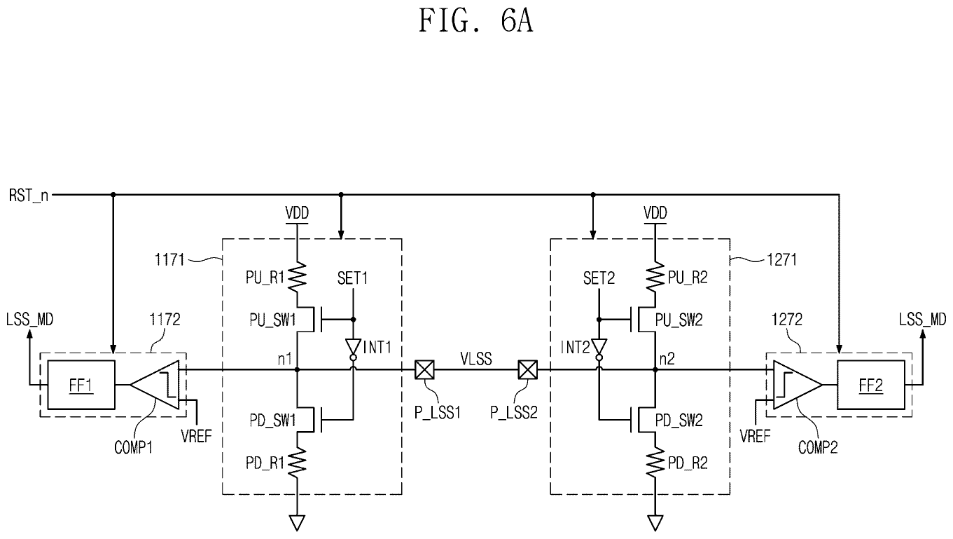

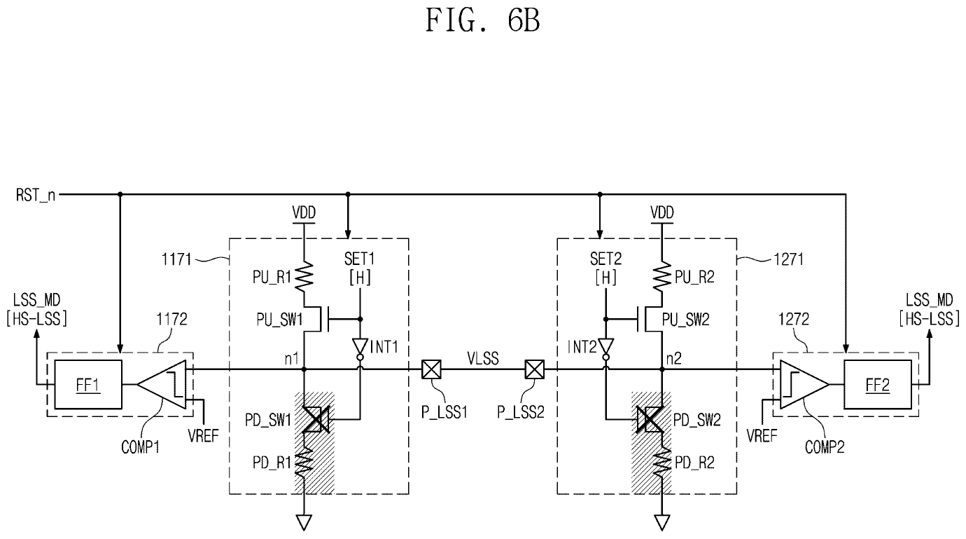

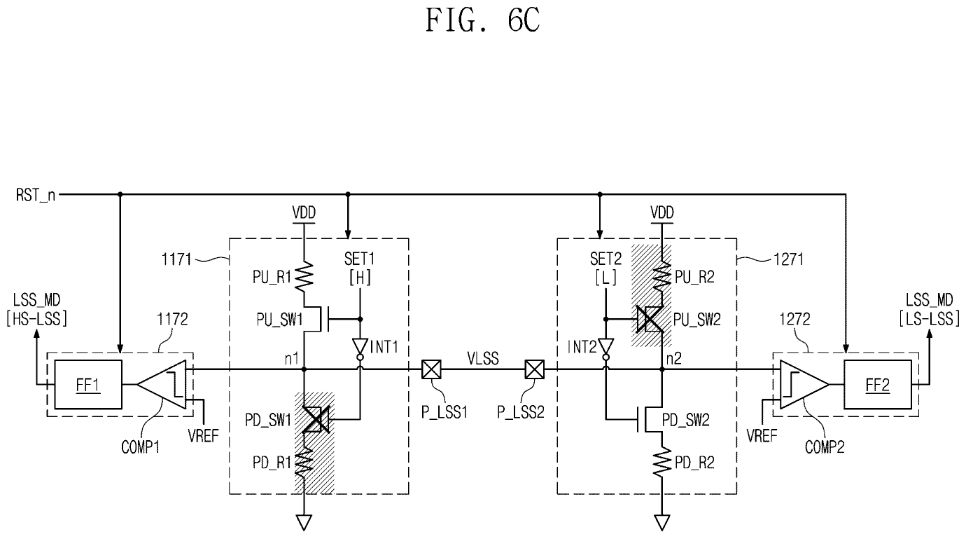

FIGS. 6A to 6C are circuit diagrams for describing a first link startup mode circuit and a second link startup mode circuit of FIG. 5 in detail.

Referring to FIGS. 1, 6A, 6B, and 6C, the first link startup mode circuit 1170 may include the first link startup mode configuring circuit 1171 and the first link startup mode determining circuit 1172. The second link startup mode circuit 1270 may include the second link startup mode configuring circuit 1271 and the second link startup mode determining circuit 1272.

The first link startup mode configuring circuit 1171 may include a first pull-up resistor PU_R1, a first pull-up switch PU_SW1, a first pull-down switch PD_SW1, a first pull-down resistor PD_R1, and a first inverter INT1. The first pull-up resistor PU_R1 and the first pull-up switch PU_SW1 may be included in the first pull-up driver, and the first pull-down switch PD_SW1 and the first pull-down resistor PD_R1 may be included in the first pull-down driver.

The first pull-up resistor PU_R1 and the first pull-up switch PU_SW1 may be connected in series between a power supply voltage VDD and a first node n1. In an implementation, the power supply voltage VDD may be the power supply voltage VDDQ being in a range of 1.14 V to 1.26 V described with reference to FIG. 1. The first node n1 may be connected to the first LSS pin P_LSS1. The first pull-up switch PU_SW1 may operate in response to the first setting signal SET1. The first pull-down switch PD_SW1 and the first pull-down resistor PD_R1 may be connected in series between the first node n1 and a ground voltage GND. The first pull-down switch PD_SW1 may operate in response to an output of the first inverter INT1 (e.g., an inverse signal of the first setting signal SET1).

The first setting signal SET1 may be set based on the link startup mode LSS_MD supportable by the UFS host 1100. For example, when the UFS host 1100 supports both the HS-LSS and the LS-LSS, the first setting signal SET1 may be at the high level. In response to the first setting signal SET1 of the high level, the first pull-up switch PU_SW1 may be turned on, and the first pull-down switch PD_SW1 may be turned off. That is, the first pull-up driver may be activated in response to the first setting signal SET1 of the high level. In this case, the first node n1 is driven with the power supply voltage VDD. When the UFS host 1100 supports only the LS-LSS, the first setting signal SET1 may be at the low level. In response to the first setting signal SET1 of the low level, the first pull-up switch PU_SW1 may be turned off, and the first pull-down switch PD_SW1 may be turned on. That is, the first pull-down driver may be activated in response to the first setting signal SET1 of the low level. In this case, the first node n1 is driven with the ground voltage GND.

The first link startup mode determining circuit 1172 may include a first comparator COMP1 and a first flip-flop FF1. The first comparator COMP1 may compare a voltage of the first node n1 (or the voltage VLSS of the LSS line) with a reference voltage VREF and may output a comparison result. As an example, when the voltage of the first node n1 is greater than the reference voltage VREF, the first comparator COMP1 may output the high level; when the voltage of the first node n1 is not greater than the reference voltage VREF, the first comparator COMP1 may output the low level.

The first flip-flop FF1 may store the output of the first comparator COMP1 in response to the reset signal RST_n and may output a signal corresponding to the link startup mode LSS_MD, based on the stored value. For example, in the reset operation of the UFS system 1000, the reset signal RST_n may toggle from the high level to the low level or from the low level to the high level. The first flip-flop FF1 may be configured to store the output of the first comparator COMP1 in synchronization with the rising edge or the falling edge of the reset signal RST_n.

The second link startup mode configuring circuit 1271 may include a second pull-up transistor PU_R2, a second pull-up switch PU_SW2, a second pull-down switch PD_SW2, a second pull-down resistor PD_R2, and a second inverter INT2. The second pull-up transistor PU_R2 and the second pull-up switch PU_SW2 may be included in the second pull-up driver, and the second pull-down switch PD_SW2 and the second pull-down resistor PD_R2 may be included in the second pull-down driver.

The second pull-up transistor PU_R2 and the second pull-up switch PU_SW2 may be connected in series between the power supply voltage VDD and a second node n2. The second node n2 may be connected to the second LSS pin P_LSS2. The second pull-up switch PU_SW2 may operate in response to the second setting signal SET2. The second pull-down switch PD_SW2 and the second pull-down resistor PD_R2 may be connected in series between the second node n2 and the ground voltage GND. The second pull-down switch PD_SW2 may operate in response to an output of the second inverter INT2 (e.g., an inverse signal of the second setting signal SET2).

The second setting signal SET2 may be set based on the link startup mode LSS_MD supportable by the UFS device 1200. For example, when the UFS device 1200 supports both the HS-LSS and the LS-LSS, the second setting signal SET2 may be at the high level. When the UFS device 1200 supports only the LS-LSS, the second setting signal SET2 may be at the low level. Operations which the second link startup mode configuring circuit 1271 performs in response to the second setting signal SET2 are similar to the operations which the first link startup mode configuring circuit 1171 performs, and thus, additional description will be omitted to avoid redundancy.

The second link startup mode determining circuit 1272 may include a second comparator COMP2 and a second flip-flop FF2. The second comparator COMP2 may compare a voltage of the second node n2 (or the voltage VLSS of the LSS line) with the reference voltage VREF and may output a comparison result. The second flip-flop FF2 may store the output of the second comparator COMP2 in response to the reset signal RST_n and may output a signal corresponding to the link startup mode LSS_MD, based on the stored value. Operations of the second comparator COMP2 and the second flip-flop FF2 are similar to the operations of the first comparator COMP1 and the first flip-flop FF1, and thus, additional description will be omitted to avoid redundancy.

In an implementation, the driving capabilities of the pull-up driver and the pull-down driver of each of the first and second link startup mode configuring circuits 1171 and 1271 may be differently set to determine the link startup mode LSS_MD supported by both the UFS host 1100 and the UFS device 1200. For example, a resistance value of each of the first and second pull-down resistors PD_R1 and PD_R2 may be greater than a resistance value of each of the first and second pull-up resistors PU_R1 and PU_R2. For convenience of description, it is assumed that the resistance value of each of the first and second pull-down resistors PD_R1 and PD_R2 is three times the resistance value of each of the first and second pull-up resistors PU_R1 and PU_R2. In this case, when at least one of the UFS host 1100 and the UFS device 1200 does not support the HS-LSS, the connecting voltage VLSS of the LSS line may become smaller than the reference voltage VREF, and thus, the UFS host 1100 and the UFS device 1200 may normally perform the LSS operation based on the LS-LSS.

As an example, the HS-LSS and the LS-LSS may be supported by the UFS host 1100 and the UFS device 1200. In this case, as illustrated in FIG. 6B, the first and second pull-down switches PD_SW1 and PD_SW2 of the first and second link startup mode configuring circuits 1171 and 1271 may be turned off. That is, the first and second pull-down drivers are deactivated. In this case, because the LSS line is driven by the first and second pull-up drivers, the connecting voltage VLSS of the LSS line may be the power supply voltage VDD. The reference voltage VREF may be ½ times the power supply voltage VDD; in this case, when the connecting voltage VLSS of the LSS line is greater than the reference voltage VREF, each of the first and second link startup mode determining circuits 1172 and 1272 may determine that the link startup mode LSS_MD is the HS-LSS.

As an example, the HS-LSS and the LS-LSS may be supported by the UFS host 1100, and the LS-LSS may be supported by the UFS device 1200. In this case, as illustrated in FIG. 6C, the first pull-down switch PD_SW1 of the first link startup mode configuring circuit 1171 may be turned off, and the second pull-up switch PU_SW2 of the second link startup mode configuring circuit 1271 may be turned off. That is, the first pull-down driver and the second pull-up driver are deactivated. In this case, the LSS line is driven by to the first pull-up driver and the second pull-down driver. Because the resistance value of the second pull-down resistor PD_R2 of the second pull-down driver is three times greater than the resistance value of the first pull-up resistor PU_R1 of the first pull-up driver, the connecting voltage VLSS of the LSS line may be ¼ times the power supply voltage (i.e., ¼×VDD). In this case, because the connecting voltage VLSS of the LSS line is smaller than the reference voltage VREF (e.g., ½ times the power supply voltage VDD), each of the first and second link startup mode determining circuits 1172 and 1272 determines that the link startup mode LSS_MD is the LS-LSS.

An implementation in which the driving capabilities of the pull-up driver and the pull-down driver of each of the first and second link startup mode configuring circuits 1171 and 1271 are differently set to determine the link startup mode LSS_MD supported by both the UFS host 1100 and the UFS device 1200 is described, but the present disclosure is not limited thereto. For example, the driving capabilities of the pull-up driver and the pull-down driver of each of the first and second link startup mode configuring circuits 1171 and 1271 may be identical to each other. In this case, when the HS-LSS is not supported by one of the UFS host 1100 and the UFS device 1200, the connecting voltage VLSS of the LSS line may be ½ times the power supply voltage VDD. In an implementation, the reference voltage VREF may be set to ⅔ times or ¾ times the power supply voltage VDD. When the connecting voltage VLSS of the LSS line is ½ times the power supply voltage VDD, the link startup mode LSS_MD may be determined as the LS-LSS.

For convenience, a configuration in which the pull-up drivers are activated when the HS-LSS and the LS-LSS are supported by the UFS host 1100 and the UFS device 1200 is described, but the present disclosure is not limited thereto. For example, when the HS-LSS and the LS-LSS are supported by each of the UFS host 1100 and the UFS device 1200, the first and second pull-down drivers may be activated; when only the LS-LSS are supported by each of the UFS host 1100 and the UFS device 1200, the first and second pull-up drivers may be activated. In this case, the driving capability of the pull-up drivers may be set to be greater than the driving capability of the pull-down drivers. According to the above description, when the connecting voltage VLSS of the LSS line is smaller than the reference voltage VREF, the first and second link startup mode determining circuits 1172 and 1272 may determine that the link startup mode LSS_MD is the HS-LSS; when the connecting voltage VLSS of the LSS line is greater than the reference voltage VREF, the first and second link startup mode determining circuits 1172 and 1272 may determine that the link startup mode LSS_MD is the LS-LSS. Alternatively, when the driving capabilities of the pull-up drivers and the pull-down drivers are identically set, the reference voltage VREF may be set to ⅓ times or ¼ times the power supply voltage VDD.

As described above, each of the UFS host 1100 and the UFS device 1200 may independently drive the LSS line based on the supportable link startup mode LSS_MD and may determine the final link startup mode LSS_MD based on the voltage of the LSS line. In this case, without separately checking link startup modes supportable by the UFS host 1100 and the UFS device 1200 and individually setting the link startup modes, the final link startup mode LSS_MD may be determined by the internal operations of the UFS host 1100 and the UFS device 1200. Accordingly, the UFS system 1000 with reduce costs and improved reliability is provided.

In an implementation, before the reset signal RST_n is set to the high level or while the reset signal RST_n is at the low level, the first and second link startup mode configuring circuits 1171 and 1271 may be configured to set the voltages of the first node n1 and the second node n2 as described above. In this case, before the reset signal RST_n is set to the high level, the connecting voltage VLSS of the LSS line may be set to a level corresponding to the link startup mode LSS_MD supportable by the UFS host 1100 and the UFS device 1200. Accordingly, in response to the rising edge of the reset signal RST_n, the first and second link startup mode determining circuits 1172 and 1272 may determine the link startup mode LSS_MD based on the connecting voltage VLSS of the LSS line.

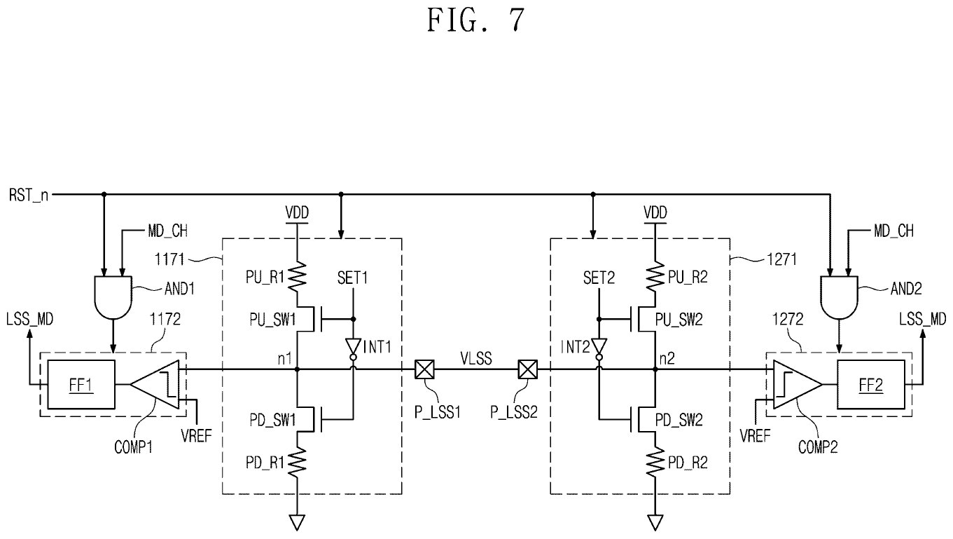

FIG. 7 is a circuit diagram illustrating a first link startup mode circuit and a second link startup mode circuit of FIG. 5. Some components of FIG. 7 are described with reference to FIGS. 6A to 6C, and thus, additional description will be omitted to avoid redundancy.

In the above implementations, before the reset signal RST_n is set to the high level, the first and second link startup mode configuring circuits 1171 and 1271 may be configured to set the voltages of the first node n1 and the second node n2 as described above. However, the present disclosure is not limited thereto.

For example, as illustrated in FIG. 7, the first link startup mode configuring circuit 1171 may include a first AND gate AND1. The first AND gate AND1 may be configured to perform the AND operation on the reset signal RST_n and a mode check signal MD_CH. The second link startup mode circuit 1271 may include a second AND gate AND2. The second AND gate AND2 may be configured to perform the AND operation on the reset signal RST_n and the mode check signal MD_CH.

In the implementation of FIG. 7, in response to that the reset signal RST_n is set to the high level, the first and second link startup mode configuring circuits 1171 and 1271 may be configured to set the voltages of the first node n1 and the second node n2 as described above. In this case, in response to that the reset signal RST_n is set to the high level, the connecting voltage VLSS of the LSS line may be set to a level corresponding to the link startup mode LSS_MD supportable by the UFS host 1100 and the UFS device 1200.

In response to the outputs of the first and second AND gates AND1 and AND2, the first and second link startup mode determining circuits 1172 and 1272 may determine the link startup mode LSS_MD based on the connecting voltage VLSS of the LSS line. For example, when both the reset signal RST_n and the mode check signal MD_CH are at the high level, the first AND gate AND1 may output a signal of the high level. The first link startup mode determining circuit 1172 may determine the link startup mode LSS_MD in response to that the output signal of the first AND gate AND1 is at the high level. The second link startup mode determining circuit 1272 may determine the link startup mode LSS_MD in response to that the output signal of the second AND gate AND2 is at the high level.

That is, as described above, the first and second link startup mode configuring circuits 1171 and 1271 may drive the voltages of the first node n1 and the second node n2 in response to that the reset signal RST_n transitions to the high level, and the first and second link startup mode determining circuits 1172 and 1272 may be configured to determine the link startup mode LSS_MD in response to that the mode check signal MD_CH transitions to the high level.

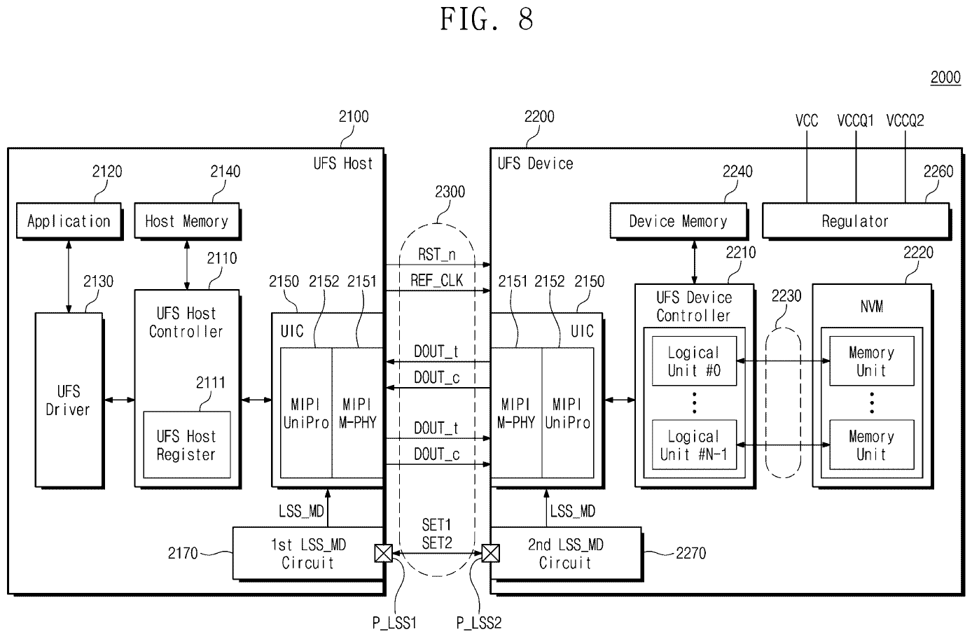

FIG. 8 is a block diagram illustrating a UFS system according to an implementation of the present disclosure. Referring to FIG. 8, a UFS system 2000 may include a UFS host 2100 and a UFS device 2200. The UFS host 2100 and the UFS device 2200 may communicate through a UFS interface 2300. The UFS host 2100 may include a UFS host controller 2110, an application 2120, a UFS driver 2130, a host memory 2140, and a UIC layer 2150. The UFS device 2200 may include a UFS device controller 2210, a nonvolatile memory 2220, a device memory 2240, a UIC layer 2250, and a regulator 2260. The UFS device controller 2210 and the nonvolatile memory 2220 may communicate through a nonvolatile memory interface 2230. The above components are described with reference to FIG. 1, and thus, additional description will be omitted to avoid redundancy.

The UFS host 2100 may include a first link startup mode circuit 2170, and the UFS device 2200 may include a second link startup mode circuit 2270. The first and second link startup mode circuits 2170 and 2270 may be connected to each other through the LSS line. In an implementation, the first link startup mode circuit 2170 may transmit the first setting signal SET1 to the second link startup mode circuit 2270 through the LSS line, and the second link startup mode circuit 2270 may transmit the second setting signal SET2 to the first link startup mode circuit 2170 through the LSS line. The first link startup mode circuit 2170 may determine the link startup mode LSS_MD based on the first setting signal SET1 and the second setting signal SET2 received through the LSS line. The second link startup mode circuit 2270 may determine the link startup mode LSS_MD based on the second setting signal SET2 and the first setting signal SET1 received through the LSS line.

For example, in the implementations described with reference to FIGS. 1 to 7, the first and second link startup mode circuits 1170 and 1270 individually drive the connecting voltage VLSS of the LSS line based on the first and second setting signals SET1 and SET2 and compare the connecting voltage VLSS of the LSS line with the reference voltage VREF to determine the link startup mode LSS_MD.

In contrast, in the implementation of FIG. 8, the first and second link startup mode circuits 2170 and 2270 may exchange the first and second setting signals SET1 and SET2 through the LSS line. Each of the first and second link startup mode circuits 2170 and 2270 may determine the link startup mode LSS_MD based on the first and second setting signals SET1 and SET2. For example, when all the first and second setting signals SET1 and SET2 are at the high level (i.e., when the HS-LSS is supported by the UFS host 2100 and the UFS device 2200), the first and second link startup mode circuits 2170 and 2270 may determine the link startup mode LSS_MD as the HS-LSS. When at least one of the first and second setting signals SET1 and SET2 is at the low level (i.e., when the HS-LSS is not supported by at least one of the UFS host 2100 and the UFS device 2200), the first and second link startup mode circuits 2170 and 2270 may determine the link startup mode LSS_MD as the LS-LSS.

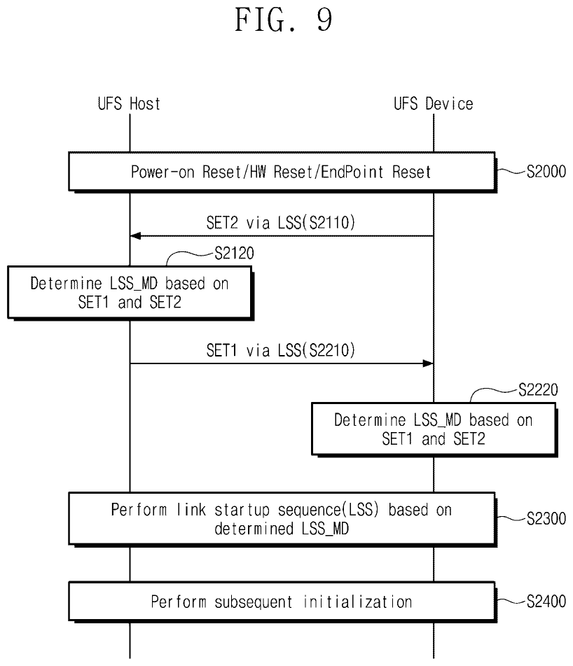

FIG. 9 is a flowchart illustrating an operation of a UFS system of FIG. 8. Referring to FIGS. 8 and 9, in operation S2000, the UFS system 2000 may perform the reset operation. Operation S2000 is similar to operation S1000 of FIG. 4, and thus, additional description will be omitted to avoid redundancy.

In operation S2110, the UFS device 2200 may transmit the second setting signal SET2 to the UFS host 2100 through the LSS pin or the LSS line. For example, the UFS device 2200 may generate the second setting signal SET2 based on a supportable link startup mode in response to the reset signal RST_n. The second link startup mode circuit 2270 of the UFS device 2200 may transmit the second setting signal SET2 to the UFS host 2100.

In operation S2120, the UFS host 2100 may determine the link startup mode LSS_MD based on the first setting signal SET1 and the second setting signal SET2. For example, the UFS host 2100 may generate the first setting signal SET1 based on a supportable link startup mode in response to the reset signal RST_n. The UFS host 2100 may determine the link startup mode LSS_MD based on the generated first setting signal SET1 and the second setting signal SET2 received through the LSS line. As an example, when all the first and second setting signals SET1 and SET2 are at the high level, the link startup mode LSS_MD may be determined as the HS-LSS; when at least one of the first and second setting signals SET1 and SET2 is at the low level, the link startup mode LSS_MD may be determined as the LS-LSS.

In operation S2210, the UFS host 2100 may transmit the first setting signal SET1 to the UFS device 2200 through the LSS line. In operation S2220, the UFS device 2200 may determine the link startup mode LSS_MD based on the first and second setting signals SET1 and SET2. In an implementation, operation S2110, operation S2120, operation S2210, and operation S2220 may be performed in parallel or simultaneously.

The UFS system 2000 may perform operation S2300 and operation S2400. Operation S2300 to operation S2400 are similar to operation S1300 to operation S1400 of FIG. 4, and thus, additional description will be omitted to avoid redundancy.

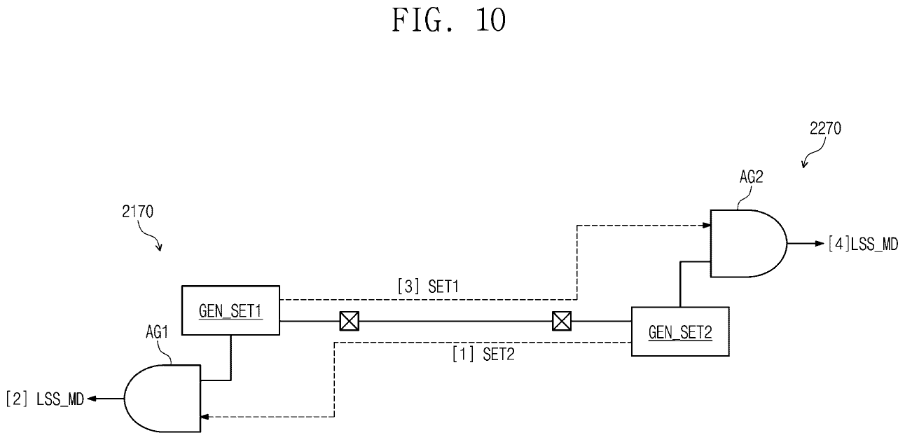

FIG. 10 is a diagram for describing first and second link startup mode circuits of FIG. 8. For brevity of drawing and for convenience of description, unnecessary components are omitted. Referring to FIGS. 8 and 10, the first link startup mode circuit 2170 may include a first setting signal generating unit GEN_SET1 and a first AND gate AG1. The second link startup mode circuit 2270 may include a second setting signal generating unit GEN_SET2 and a second AND gate AG2.

In the initialization operation, the first setting signal generating unit GEN_SET1 of the UFS host 2100 may generate the first setting signal SET1 based on a supportable link startup mode. The second setting signal generating unit GEN_SET2 of the UFS device 2200 may generate the second setting signal SET2 based on a supportable link startup mode.

The second setting signal generating unit GEN_SET2 may transmit the second setting signal SET2 to the UFS host 2100 through the LSS line (step [1] of FIG. 10). The first AND gate AG1 of the first link startup mode circuit 2170 may perform the AND operation on the second setting signal SET2 received through the LSS line and the first setting signal SET1 generated by the first setting signal generating unit GEN_SET1 and may output a signal associated with the link startup mode LSS_MD (step [2] of FIG. 10).

The first setting signal generating unit GEN_SET1 may transmit the first setting signal SET1 to the UFS device 2200 through the LSS line (step [3] of FIG. 10). The second AND gate AG2 of the second link startup mode circuit 2270 may perform the AND operation on the first setting signal SET1 received through the LSS line and the second setting signal SET2 generated by the second setting signal generating unit GEN_SET2 and may output a signal associated with the link startup mode LSS_MD (step [4] of FIG. 10).

As described above, the UFS host 2100 and the UFS device 2200 may directly exchange the first and second setting signals SET1 and SET2 generated based on the supportable link startup mode LSS_MD. According to the above description, an operation in which the system vendor individually checks the supportable link startup modes of the UFS host 2100 and the UFS device 2200 or individually sets the link startup modes is not required.

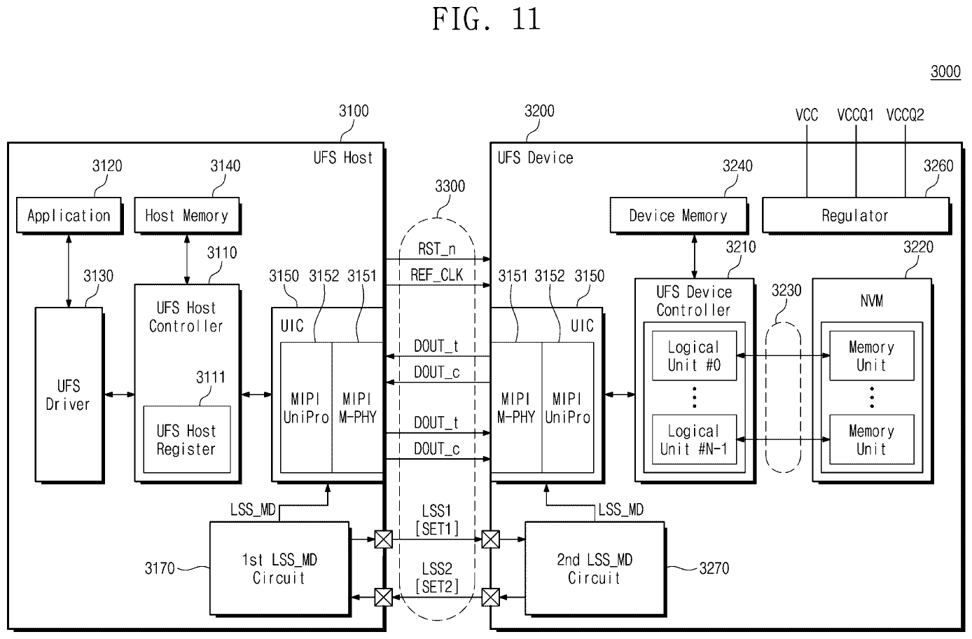

FIG. 11 is a block diagram illustrating a UFS system according to an implementation of the present disclosure. Referring to FIG. 11, a UFS system 3000 may include a UFS host 3100 and a UFS device 3200. The UFS host 3100 and the UFS device 3200 may communicate through a UFS interface 3300. The UFS host 3100 may include a UFS host controller 3110, an application 3120, a UFS driver 3130, a host memory 3140, and a UIC layer 3150. The UFS device 3200 may include a UFS device controller 3210, a nonvolatile memory 3220, a device memory 3240, a UIC layer 3250, and a regulator 3260. The UFS device controller 3210 and the nonvolatile memory 3220 may communicate through a nonvolatile memory interface 3230. The above components are described with reference to FIG. 1, and thus, additional description will be omitted to avoid redundancy.

The UFS host 3100 may include a first link startup mode circuit 3170. The UFS device 3200 may include a second link startup mode circuit 3270. The first and second link startup mode circuits 3170 and 3270 may be connected to each other through first and second LSS lines LSS1 and LSS2. The first link startup mode circuit 3170 may transmit the first setting signal SET1 to the UFS device 3200 through the first LSS line LSS1. The second link startup mode circuit 3270 may transmit the second setting signal SET2 to the UFS host 3100 through the second LSS line LSS2.

The first link startup mode circuit 3170 may determine the link startup mode LSS_MD based on the first setting signal SET1 and the second setting signal SET2 received through the second LSS line LSS2. The second link startup mode circuit 3270 may determine the link startup mode LSS_MD based on the second setting signal SET2 and the first setting signal SET1 received through the first LSS line LSS1. Operations of the first and second link startup mode circuits 3170 and 3270 of FIG. 11 are similar to the operations of the first and second link startup mode circuits 2170 and 2270 of FIG. 8 except that the first and second setting signals SEL1 and SEL2 are transmitted/received through the first and second LSS lines LSS1 and LSS2, and thus, additional description will be omitted to avoid redundancy.

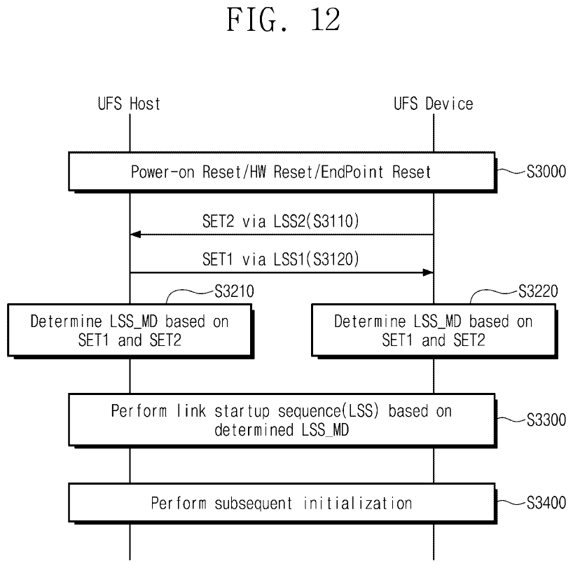

FIG. 12 is a flowchart illustrating an operation of a UFS system of FIG. 11. Referring to FIGS. 11 and 12, in operation S3000, the UFS system 3000 may perform the reset operation. Operation S3000 is similar to operation S1000 of FIG. 4, and thus, additional description will be omitted to avoid redundancy.

In operation S3110, the UFS device 3200 may transmit the second setting signal SET2 to the UFS host 3100 through the second LSS line LSS2. In operation S3120, the UFS host 3100 may transmit the first setting signal SET1 to the UFS device 3200 through the first LSS line LSS1.

In operation S3210, the UFS host 3100 may determine the link startup mode LSS_MD based on the first and second setting signals SET1 and SET2. In operation S3220, the UFS device 3200 may determine the link startup mode LSS_MD based on the first and second setting signals SET1 and SET2.

The UFS system 3000 may perform operation S3300 and operation S3400. Operation S3300 to operation S3400 are similar to operation S1300 to operation S1400 of FIG. 4, and thus, additional description will be omitted to avoid redundancy.

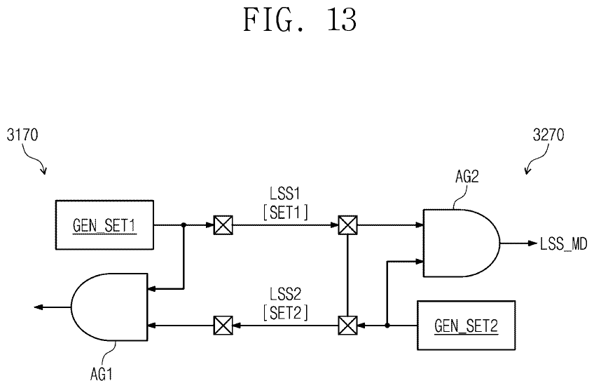

FIG. 13 is a diagram illustrating first and second link startup mode circuits of FIG. 11. For brevity of drawing and for convenience of description, unnecessary components are omitted. Referring to FIGS. 11 and 13, the first link startup mode circuit 3170 may include the first setting signal generating unit GEN_SET1 and the first AND gate AG1. The second link startup mode circuit 3270 may include a second setting signal generating unit GEN_SET2 and the second AND gate AG2.

In the initialization operation, the first setting signal generating unit GEN_SET1 may generate the first setting signal SET1 based on a supportable link startup mode, and the second setting signal generating unit GEN_SET2 may generate the second setting signal SET2 based on a supportable link startup mode. The first setting signal SET1 may be transmitted to the UFS device 3200 through the first LSS line LSS1, and the second setting signal SET2 may be transmitted to the UFS host 3100 through the second LSS line LSS2.

The first AND gate AG1 may perform the AND operation on the first setting signal SET1 generated by the first setting signal generating unit GEN_SET1 and the second setting signal SET2 received through the second LSS line LSS2 and may output a signal associated with the link startup mode LSS_MD. The second AND gate AG2 may perform the AND operation on the second setting signal SET2 generated by the second setting signal generating unit GEN_SET2 and the first setting signal SET1 received through the first LSS line LSS1 and may output a signal associated with the link startup mode LSS_MD.

In the implementation described with reference to FIGS. 11 to 13, operation S3110 and operation S3120 (i.e., operations of transmitting/receiving the first and second setting signals SET1 and SET2) may be simultaneously performed. For example, in the implementation described with reference to FIGS. 8 to 10, the first and second link startup mode circuits 2170 and 2270 exchange the first and second setting signals SET1 and SET2 through one LSS line. In this case, after the UFS device 2200 transmits the second setting signal SET2 to the UFS host 2100, the UFS host 2100 may transmit the first setting signal SET1 to the UFS device 2200. Alternatively, after the UFS host 2100 transmits the first setting signal SET1 to the UFS device 2200, the UFS device 2200 may transmit the second setting signal SET2 to the UFS host 2100. That is, in the implementation of FIGS. 8 to 10, the operations of transmitting/receiving the first and second setting signals SET1 and SET2 may be sequentially performed.

In contrast, in the implementation of FIGS. 11 to 13, the first and second link startup mode circuits 3170 and 3270 exchange the first and second setting signals SET1 and SET2 through two LSS lines LSS1 and LSS2. In this case, the UFS host 3100 may transmit the first setting signal SET1 to the UFS device 3200 through the first LSS line LSS1, and the UFS device 3200 may transmit the second setting signal SET2 to the UFS host 3100 through the second LSS line LSS2. That is, the operations of transmitting/receiving the first and second setting signals SET1 and SET2 may be simultaneously performed.

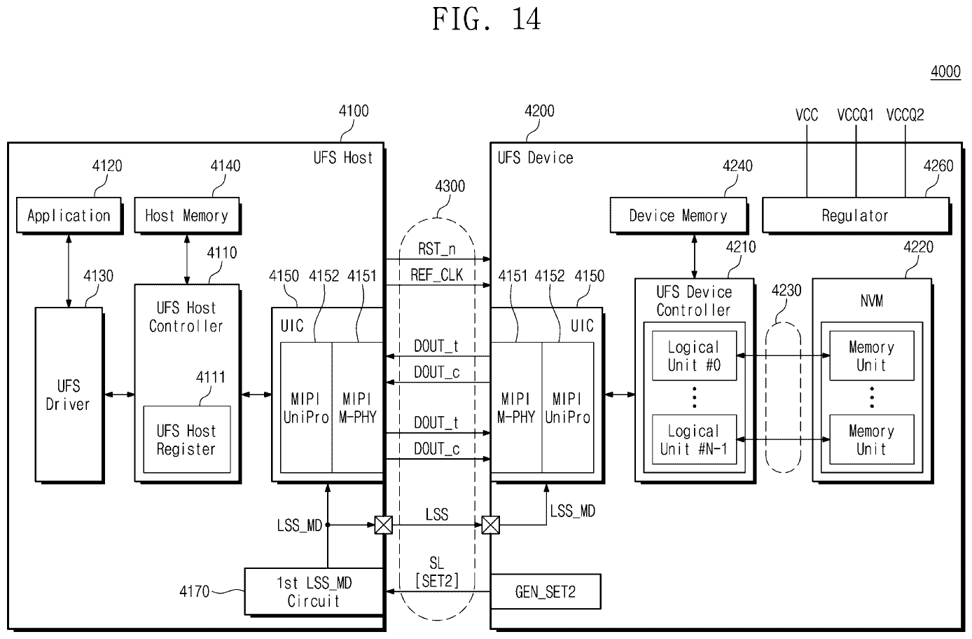

FIG. 14 is a block diagram illustrating a UFS system according to an implementation of the present disclosure. Referring to FIG. 14, a UFS system 4000 may include a UFS host 4100 and a UFS device 4200. The UFS host 4100 and the UFS device 4200 may communicate through a UFS interface 4300. The UFS host 4100 may include a UFS host controller 4110, an application 4120, a UFS driver 4130, a host memory 4140, and a UIC layer 4150. The UFS device 4200 may include a UFS device controller 4210, a nonvolatile memory 4220, a device memory 4240, a UIC layer 4250, and a regulator 4260. The UFS device controller 4210 and the nonvolatile memory 4220 may communicate through a nonvolatile memory interface 4230. The above components are described with reference to FIG. 1, and thus, additional description will be omitted to avoid redundancy.

The UFS host 4100 may include a first link startup mode circuit 4170. The UFS device 4200 may include the second setting signal generating unit GEN_SET2. The second setting signal generating unit GEN_SET2 of the UFS device 4200 may generate the second setting signal SET2 based on a link startup mode supportable by the UFS device 4200, in response to the reset signal RST_n. The second setting signal SET2 may be provided to the UFS host 4100 through an individual control line SL.

The first link startup mode circuit 4170 of the UFS host 4100 may receive the second setting signal SET2 through the individual control line SL. The first link startup mode circuit 4170 may determine the link startup mode LSS_MD based on the first setting signal SET1, which the UFS host 4100 generates based on the supportable link startup mode, and the second setting signal SET2 received through the individual control line SL. The first link startup mode circuit 4170 may provide the signal associated with the determined link startup mode LSS_MD to the UIC layer 4150 of the UFS host 4100 and may provide the signal associated with the determined link startup mode LSS_MD to the UIC layer 4250 of the UFS device 4200 through LSS line. Alternatively, the first link startup mode circuit 4170 may configure or drive the LSS line or the LSS pin of the UFS device 4200 based on the determined link startup mode LSS_MD.

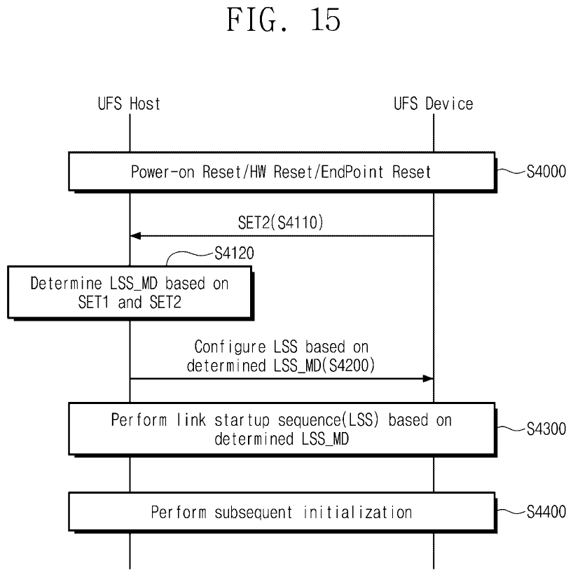

FIG. 15 is a flowchart illustrating an operation of a UFS system of FIG. 14. Referring to FIGS. 14 and 15, in operation S4000, the UFS system 4000 may perform the reset operation. Operation S4000 is similar to operation S1000 of FIG. 4, and thus, additional description will be omitted to avoid redundancy.

In operation S4110, the UFS device 4200 may transmit the second setting signal SET2 to the UFS host 4100. For example, the second setting signal generating unit GEN_SET2 of the UFS device 4200 may generate the second setting signal SET2 based on the supportable link startup mode, in response to the reset signal RST_n. The generated second setting signal SET2 may be transmit to the UFS host 4100 through the individual control line SL.

In operation S4120, the UFS host 4100 may determine the link startup mode LSS_MD based on the first setting signal SET1 and the second setting signal SET2. For example, the first link startup mode circuit 4170 of the UFS host 4100 may generate the first setting signal SET1 based on the link startup mode supportable by the UFS host 4100. The first link startup mode circuit 4170 may perform the AND operation on the first setting signal SET1 and the second setting signal SET2 received through the individual control line SL and may determine the link startup mode LSS_MD. In an implementation, an operation of the first link startup mode circuit 4170 is similar to the operation of the first link startup mode circuit 3170 of FIGS. 11 to 13 except that the second setting signal SET2 is received through the individual control line SL, and thus, additional description will be omitted to avoid redundancy.

In operation S4200, the UFS host 4100 may configure or drive the LSS line or the LSS pin of the UFS device 4200 based on the determined link startup mode LSS_MD. For example, when the determined link startup mode LSS_MD is the HS-LSS, the UFS host 4100 may drive the LSS line or the LSS pin of the UFS device 4200 with the high level or may configure the LSS line or the LSS pin of the UFS device 4200 with the high level. Alternatively, when the determined link startup mode LSS_MD is the LS-LSS, the UFS host 4100 may drive the LSS line or the LSS pin of the UFS device 4200 with the low level or may configure the LSS line or the LSS pin of the UFS device 4200 with the low level. In an implementation, the UIC layer 4250 of the UFS device 4200 may initiate the LSS operation based on the link startup mode LSS_MD corresponding to the level of the LSS line or the LSS pin.

The UFS system 4000 may perform operation S4300 and operation S4400. Operation S4300 to operation S4400 are similar to operation S1300 to operation S1400 of FIG. 4, and thus, additional description will be omitted to avoid redundancy.

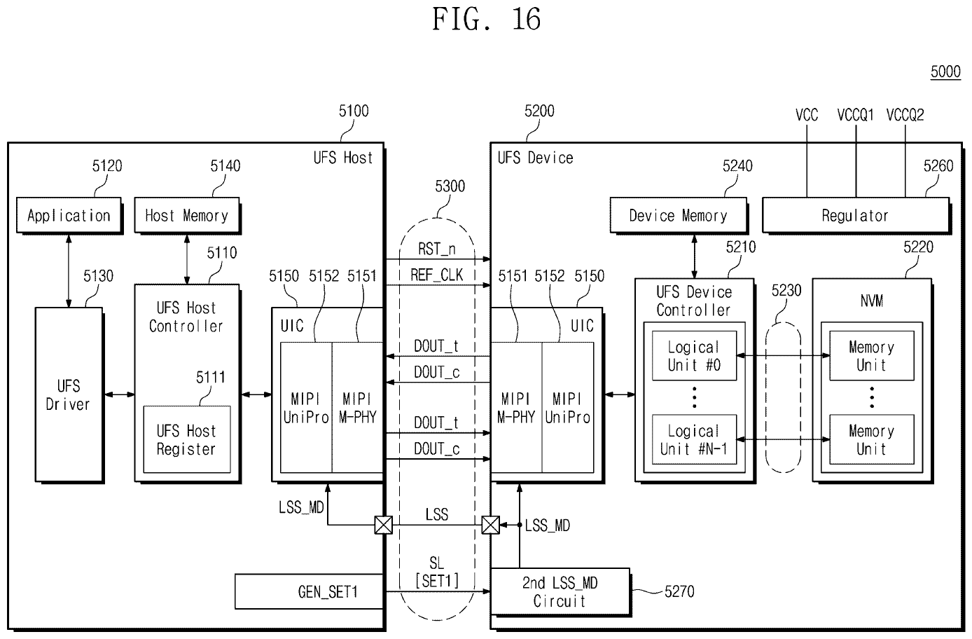

FIG. 16 is a block diagram illustrating a UFS system according to an implementation of the present disclosure. Referring to FIG. 16, a UFS system 5000 may include a UFS host 5100 and a UFS device 5200. The UFS host 5100 and the UFS device 5200 may communicate through a UFS interface 5300. The UFS host 5100 may include a UFS host controller 5110, an application 5120, a UFS driver 5130, a host memory 5140, and a UIC layer 5150. The UFS device 5200 may include a UFS device controller 5210, a nonvolatile memory 5220, a device memory 5240, a UIC layer 5250, and a regulator 5260. The UFS device controller 5210 and the nonvolatile memory 5220 may communicate through a nonvolatile memory interface 5230. The above components are described with reference to FIG. 1, and thus, additional description will be omitted to avoid redundancy.

The UFS device 5200 may include a second link startup mode circuit 5270. The UFS host 5100 may include the first setting signal generating unit GEN_SET1. The first setting signal generating unit GEN_SET1 may generate the first setting signal SET1 in response to the reset signal RST_n. The first setting signal SET1 may be transmitted to the UFS device 5200 through the individual control line SL. The second link startup mode circuit 5270 of the UFS device 5200 may determine the link startup mode LSS_MD based on the first setting signal SET1 and the second setting signal SET2. The second link startup mode circuit 5270 may transmit a signal corresponding to the determined link startup mode LSS_MD to the UIC layer 5250. The second link startup mode circuit 5270 may transmit a signal corresponding to the determined link startup mode LSS_MD to the UFS host 5100 through the LSS line. The UFS host 5100 may provide the UIC layer 5150 with the signal corresponding to the link startup mode LSS_MD, which is received from the LSS line.

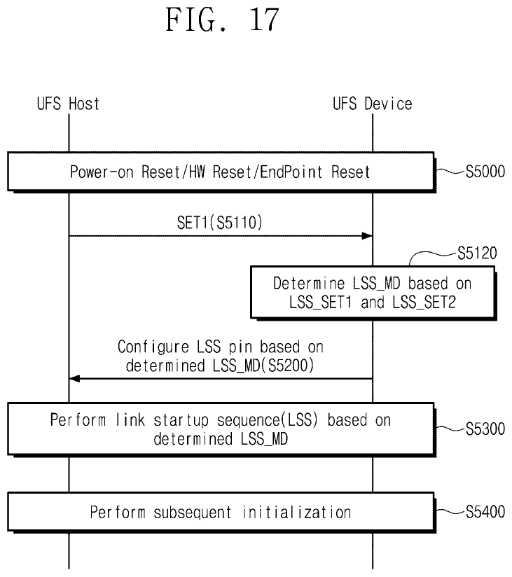

FIG. 17 is a flowchart illustrating an operation of a UFS system of FIG. 16. Referring to FIGS. 16 and 17, in operation S5000, the UFS system 5000 may perform the reset operation. Operation S5000 is similar to operation S1000 of FIG. 4, and thus, additional description will be omitted to avoid redundancy.

In operation S5110, the UFS host 5100 may transmit the first setting signal SET1 to the UFS device 5200. In an implementation, the first setting signal SET1 may be transmitted to the UFS device 5200 through the individual control line SL. In operation S5120, the UFS device 5200 may determine the link startup mode LSS_MD based on the first setting signal SET1 and the second setting signal SET2. In operation S5200, the UFS device 5200 may drive or configure the LSS line or the LSS pin based on the determined link startup mode. In an implementation, the UIC layer 5150 of the UFS host 5100 may initiate the LSS operation based on the link startup mode LSS_MD corresponding to the level of the LSS line or the LSS pin.

In the implementation of FIGS. 16 and 17, operation S5110, operation S5120, and operation S5200 are similar to operation S4110, operation S4120, and operation S4200 of the implementation of FIGS. 14 and 15 except that the link startup mode is determined by the UFS device 5200, and thus, additional description will be omitted to avoid redundancy.

As described above, according to implementations of the present disclosure, each of the UFS host or the UFS device may drive/control the LSS line based on a supportable link startup mode, or the UFS host or the UFS device may change the corresponding setting signals. In this case, without external intervention (e.g., intervention of the system vendor), each of the UFS host or the UFS device may internally determine a link startup mode supportable by both the UFS host or the UFS device, and the LSS operation may be normally performed based on the determined link startup mode.

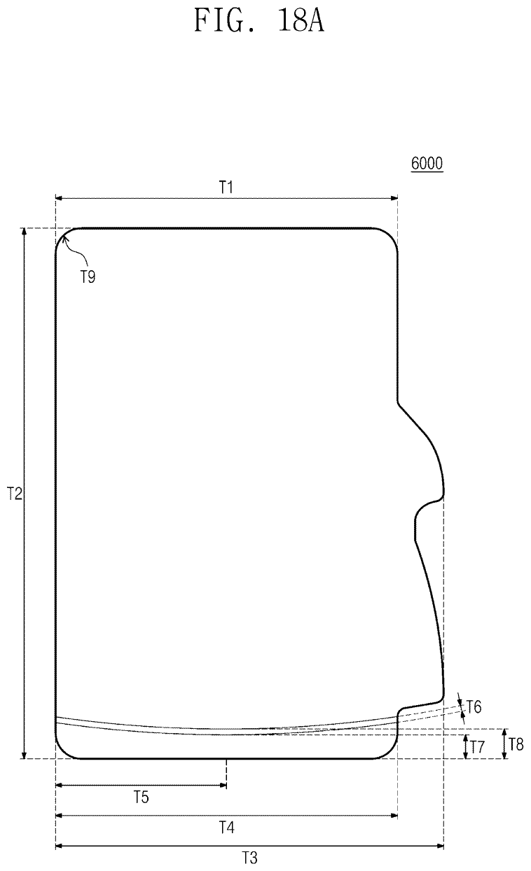

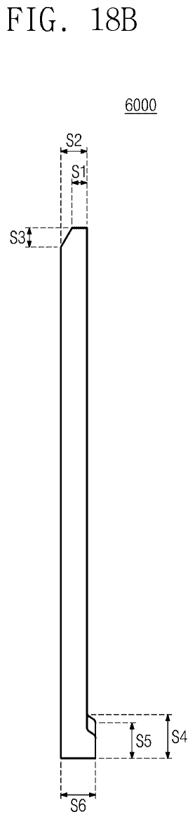

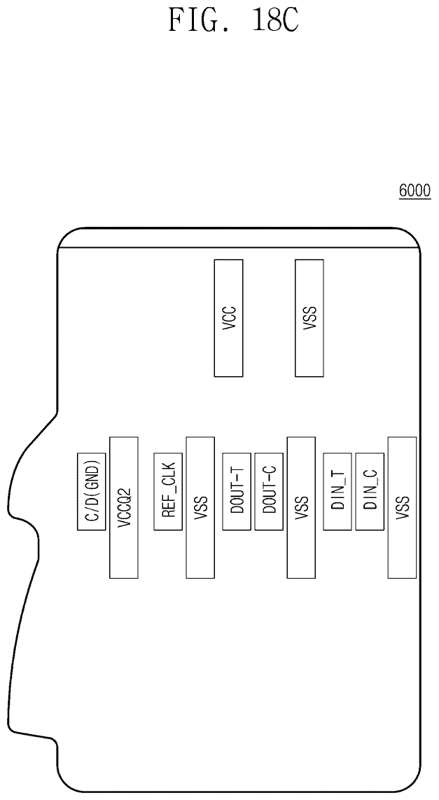

FIGS. 18A to 18C are diagrams of an example of a form factor of a UFS card 6000. When the UFS device 1000, 2000, 3000, 4000, or 5000 as above is implemented as the UFS card 6000, an outer appearance of the UFS card 6000 may be as shown in FIGS. 18A to 18C.

FIG. 18A is a top view of an example of the UFS card 6000. Referring to FIG. 18A, it can be seen that the UFS card 6000 follows a shark fin-shaped design. In FIG. 18A, the UFS card 6000 may have dimensions shown in Table 1 below as an example.

TABLE 1

| Item | Dimension (mm) |
|---|---|
| T1 | 9.70 |
| T2 | 15.00 |
| T3 | 11.00 |
| T4 | 9.70 |
| T5 | 5.15 |
| T6 | 0.25 |
| T7 | 0.60 |
| T8 | 0.75 |
| T9 | 0.80 |

FIG. 18B is a side view of the UFS card 6000. In FIG. 18B, the UFS card 6000 may have dimensions shown in Table 2 below as an example.

TABLE 2

| Item | Dimension (mm) |
|---|---|
| S1 | 0.74 ± 0.06 |
| S2 | 0.30 |
| S3 | 0.52 |
| S4 | 1.20 |
| S5 | 1.05 |
| S6 | 1.00 |

FIG. 18C is a bottom view of the UFS card 6000. Referring to FIG. 18C, a plurality of pins for electrical contact with a UFS slot may be formed on a bottom surface of the UFS card 6000. Functions of each of the pins will be described below. Based on symmetry between a top surface and the bottom surface of the UFS card 6000, some pieces (e.g., T1 to T5 and T9) of information about the dimensions described with reference to FIG. 18A and Table 1 may also be applied to the bottom view of the UFS card 6000, which is shown in FIG. 18C.

A plurality of pins for an electrical connection with a UFS host may be formed on the bottom surface of the UFS card 6000. Referring to FIG. 18C, a total number of pins may be 12. Each of the pins may have a rectangular shape, and signal names corresponding to the pins may be as shown in FIG. 18C. Specific information about each of the pins will be understood with reference to Table 3 below and the above description presented with reference to FIG. 14.

TABLE 3

| No. | Signal Name | Description | Dimension (mm²) |
|---|---|---|---|
| 1 | Vss | Ground (GND) | 3.00 × 0.72 ± 0.05 |
| 2 | DIN_C | Differential input signals input from a host | 1.50 × 0.72 ± 0.05 |
| 3 | DIN_T | to the UFS card 6000 (DIN_C is a negative | |
| | | node, and DIN_T is a positive node) | |
| 4 | Vss | Ground (GND) | 3.00 × 0.72 ± 0.05 |
| 5 | DOUT_C | Differential output signals output from the | 1.50 × 0.72 ± 0.05 |
| 6 | DOUT_T | UFS card 6000 to the host (DOUT_C is | |
| | | a negative node, and DOUT_T is a positive | |
| | | node) | |
| 7 | Vss | Ground (GND) | 3.00 × 0.72 ± 0.05 |
| 8 | REF_CLK | Reference clock signal provided from the | 1.50 × 0.72 ± 0.05 |
| | | host to the UFS card 6000 | |
| 9 | VCCQ2 | Power supply voltage provided mainly to | 3.00 × 0.72 ± 0.05 |
| | | a PHY interface or a controller and having | |
| | | a lower value than voltage Vcc | |
| 10 | C/D(GND) | Card detection signal | 1.50 × 0.72 ± 0.05 |
| 11 | Vss | Ground (GND) | 3.00 × 0.80 ± 0.05 |
| 12 | Vcc | Main power supply voltage | |

In an implementation, as described with reference to FIGS. 1 to 17, the UFS card 6000 may further include a LSS pin for determining a link startup sequence mode LSS_MD. The UFS card 6000 may determine the link startup sequence mode LSS_MD based on methods described with reference to FIGS. 1 to 17.

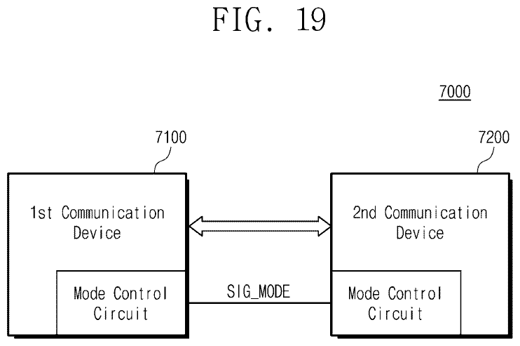

FIG. 19 is a block diagram illustrating a system according to an implementation of the present disclosure. Referring to FIG. 19, the system 7000 may include a first communication device 7100 and a second communication device 7200. The first and second communication devices 7100 and 7200 may be a controller and a memory device which are included in a storage device such as a solid state drive (SSD), respectively. Alternatively, The first and second communication devices 7100 and 7200 may be a storage device and a host controller configured to control the storage device, respectively.

In an implementation, the first and second communication devices 7100 and 7200 may communicate with each other via a predefined communication protocol. Each of the first and second communication devices 7100 and 7200 may be configured to support various operation modes. Here, if the operation modes of the first and second communication devices 7100 and 7200 do not match to each other, the first and second communication devices 7100 and 7200 cannot operate normally.

In an implementation, each of the first and second communication devices 7100 and 7200 may include a mode control circuit. The mode control circuit in each of the first and second communication devices 7100 and 7200 may be configured to exchange with a mode signal SIG_MODE with each other. The mode signal SIG_MODE may indicate an operation mode being available in each of the first and second communication devices 7100 and 7200. The mode control circuit may determine the operation modes of the first and second communication devices 7100 and 7200 based on the mode signal SIG_MODE. In an implementation, the mode control circuits of the first and second communication devices 7100 and 7200 may operate as similar with the link startup mode circuit described with reference to FIGS. 1 to 17.

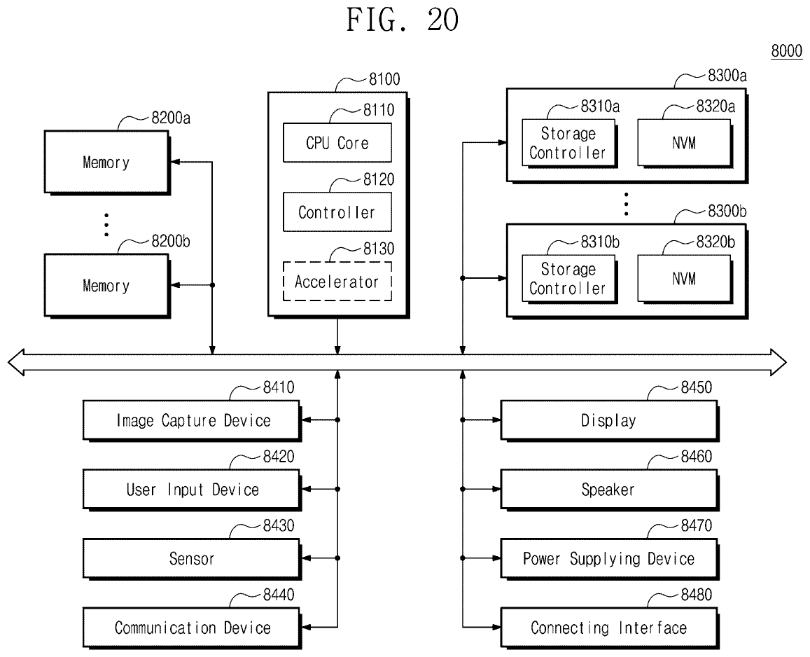

FIG. 20 is a diagram of an example of a system including one of the described storage devices. The system 8000 of FIG. 20 may basically be a mobile system, such as a portable communication terminal (e.g., a mobile phone), a smartphone, a tablet personal computer (PC), a wearable device, a healthcare device, or an Internet of things (IOT) device. However, the system 8000 of FIG. 20 is not necessarily limited to the mobile system and may be a PC, a laptop computer, a server, a media player, or an automotive device (e.g., a navigation device).

Referring to FIG. 20, the system 8000 includes a main processor 8100, memories (e.g., 8200a and 8200b), and storage devices (e.g., 8300a and 8300b). In addition, the system 8000 may include at least one of an image capturing device 8410, a user input device 8420, a sensor 8430, a communication device 8440, a display 8450, a speaker 8460, a power supplying device 8470, and a connecting interface 8480.

The main processor 8100 may control all operations of the system 8000, more specifically, operations of other components included in the system 8000. The main processor 8100 may be implemented as a general-purpose processor, a dedicated processor, or an application processor.

The main processor 8100 may include at least one CPU core 8110 and further include a controller 8120 configured to control the memories 8200a and 8200b and/or the storage devices 8300a and 8300b. In some implementations, the main processor 8100 may further include an accelerator 8130, which is a dedicated circuit for a high-speed data operation, such as an artificial intelligence (AI) data operation. The accelerator 8130 may include a graphics processing unit (GPU), a neural processing unit (NPU), and/or a data processing unit (DPU) and be implemented as a chip that is physically separate from the other components of the main processor 8100.

The memories 8200a and 8200b may be used as main memory devices of the system 1000. Although each of the memories 8200a and 8200b may include a volatile memory, such as static random access memory (SRAM) and/or dynamic RAM (DRAM), each of the memories 8200a and 8200b may include non-volatile memory, such as a flash memory, phase-change RAM (PRAM) and/or resistive RAM (RRAM). The memories 8200a and 8200b may be implemented in the same package as the main processor 8100.

The storage devices 8300a and 8300b may serve as non-volatile storage devices configured to store data regardless of whether power is supplied thereto and have larger storage capacity than the memories 8200a and 8200b. The storage devices 8300a and 8300b may respectively include storage controllers (STRG CTRL) 8310a and 8310b and NVMs (Non-Volatile Memories) 8320a and 8320b configured to store data via the control of the storage controllers 8310a and 8310b. Although the NVMs 8320a and 8320b may include flash memories having a two-dimensional (2D) structure or a three-dimensional (3D) V-NAND structure, the NVMs 8320a and 8320b may include other types of NVMs, such as PRAM and/or RRAM.

The storage devices 8300a and 8300b may be physically separated from the main processor 8100 and included in the system 8000 or implemented in the same package as the main processor 8100. In addition, the storage devices 8300a and 8300b may have types of solid-state devices (SSDs) or memory cards and be removably combined with other components of the system 8000 through an interface, such as the connecting interface 8480 that will be described below. The storage devices 8300a and 8300b may be devices to which a standard protocol, such as a universal flash storage (UFS), an embedded multi-media card (eMMC), or a non-volatile memory express (NVMe), is applied, without being limited thereto.

The image capturing device 8410 may capture still images or moving images. The image capturing device 8410 may include a camera, a camcorder, and/or a webcam.

The user input device 8420 may receive various types of data input by a user of the system 8000 and include a touch pad, a keypad, a keyboard, a mouse, and/or a microphone.

The sensor 8430 may detect various types of physical quantities, which may be obtained from the outside of the system 8000 and convert the detected physical quantities into electric signals. The sensor 8430 may include a temperature sensor, a pressure sensor, an illuminance sensor, a position sensor, an acceleration sensor, a biosensor, and/or a gyroscope sensor.

The communication device 8440 may transmit and receive signals between other devices outside the system 8000 according to various communication protocols. The communication device 8440 may include an antenna, a transceiver, and/or a modem.

The display 8450 and the speaker 8460 may serve as output devices configured to respectively output visual information and auditory information to the user of the system 8000.

The power supplying device 8470 may appropriately convert power supplied from a battery (not shown) embedded in the system 8000 and/or an external power source and supply the converted power to each of the components of the system 8000.

The connecting interface 8480 may provide a connection between the system 8000 and an external device, which is connected to the system 8000 and capable of transmitting and receiving data to and from the system 8000. The connecting interface 8480 may be implemented by using various interface schemes, such as advanced technology attachment (ATA), serial ATA (SATA), external SATA (e-SATA), small computer small interface (SCSI), serial attached SCSI (SAS), peripheral component interconnection (PCI), PCI express (PCIe), NVMe, IEEE 1394, a universal serial bus (USB) interface, a secure digital (SD) card interface, a multi-media card (MMC) interface, an eMMC interface, a UFS interface, an embedded UFS (eUFS) interface, and a compact flash (CF) card interface.

In an implementation, the storage devices 8300a and 8300b of FIG. 20 may be the UFS device described with reference to FIGS. 1 to 18C, and the main processor 8100 of FIG. 20 may be the UFS host described with reference to FIGS. 1 to 18C or may be configured to include the UFS host.

According to the present disclosure, a universal flash storage (UFS) system include a UFS host and a UFS device. The UFS host and the UFS device may support different link startup sequence (LSS) modes. In this case conventionally, a system vendor should determine a supportable link startup mode through data sheets of the UFS host and the UFS device and should individually set the link startup mode for each of the UFS host and the UFS device.

In contrast, according to the present disclosure, each of the UFS host and the UFS device may internally determine a link startup mode supportable by both the UFS host and the UFS device. Accordingly, even though the system vendor individually does not set the link startup modes, the UFS host and the UFS device may normally perform the LSS operation. Accordingly, a universal flash storage device with reduced costs and improved reliability, a universal storage system, an operation method of the universal storage system are provided.

According to an embodiment of the present disclosure, a universal flash storage (UFS) host includes a UFS interconnect (UIC) layer configured to communicate with an external UFS device, a UFS host controller configured to exchange a UFS protocol information unit (UPIU) with the external UFS device through the UIC layer, and a link startup mode circuit configured to drive a first pin with a power supply voltage based on a high speed-link startup sequence (HS-LSS) for the UIC layer being supported and to drive the first pin with a ground voltage based on the HS-LSS for the UIC layer being not supported, and the first pin is electrically connected to the external UFS device.

In an embodiment, in a reset operation of the external UFS device, the UFS host is configured to transmit a reset signal to the external UFS device, the link startup mode circuit is configured to, based on the reset signal and a voltage of the first pin, select one of the HS-LSS and a low speed-LSS (LS-LSS) as a link startup mode for the UIC layer, and the UIC layer is configured to perform a link startup sequence operation with the external UFS device based on the selected link startup mode.

According to an embodiment of the present disclosure, a universal flash storage (UFS) host includes a UFS interconnect (UIC) layer configured to communicate with an external UFS device, a UFS host controller configured to exchange a UFS protocol information unit (UPIU) with the external UFS device through the UIC layer, and a link startup mode circuit configured to receive a first setting signal from the external UFS device and to select a link startup mode based on the first setting signal and a second setting signal, the first setting signal indicates that a high speed-link startup sequence (HS-LSS) is supported by the external UFS device, or that the HS-LSS is not supported by the external UFS device, and the second setting signal indicates that the HS-LSS is supported by the UFS host, or that the HS-LSS is not supported by the UFS host.

In an embodiment, the link startup mode circuit is configured to transmit a signal corresponding to the selected link startup mode to the external UFS device, and the UIC layer is configured to initiate, based on the selected link startup mode, a link startup sequence (LSS) operation with the external UFS device.

According to an embodiment of the present disclosure, a universal flash storage (UFS) device includes a UFS interconnect (UIC) layer configured to communicate with an external UFS host, a nonvolatile memory, a UFS device controller configured to control the nonvolatile memory based on a command received from the UIC layer, and a link startup mode circuit configured to receive a first setting signal from the external UFS host and to select a link startup mode based on the first setting signal and a second setting signal, the first setting signal indicates that a high speed-link startup sequence (HS-LSS) is supported by the external UFS host, or that the HS-LSS is not supported by the external UFS host, and the second setting signal indicates that the HS-LSS is supported by the UFS device, or that the HS-LSS is not supported by the UFS device.

In an embodiment, the link startup mode circuit is configured to transmit a signal corresponding to the selected link startup mode to the external UFS host, and the UIC layer is configured to initiate, based on the selected link startup mode, a link startup sequence (LSS) operation with the external UFS host.

While this disclosure contains many specific implementation details, these should not be construed as limitations on the scope of what may be claimed. Certain features that are described in this disclosure in the context of separate implementations can also be implemented in combination in a single implementation. Conversely, various features that are described in the context of a single implementation can also be implemented in multiple implementations separately or in any suitable subcombination. Moreover, although features may be described above as acting in certain combinations, one or more features from a combination can in some cases be excised from the combination, and the combination may be directed to a subcombination or variation of a subcombination.

1. A universal flash storage (UFS) system comprising:
a UFS host including a first UFS interconnect (UIC) layer and a first pin; and
a UFS device including a second UIC layer configured to communicate with the first UIC layer and a second pin electrically connected to the first pin,
wherein the UFS host is configured to drive a voltage of the first pin based on first information indicating that a high speed-link startup sequence (HS-LSS) is supported by the UFS host, or that the HS-LSS is not supported by the UFS host, and
wherein the UFS device is configured to drive a voltage of the second pin based on second information indicating that the HS-LSS is supported by the UFS device, or that the HS-LSS is not supported by the UFS device.

2. The UFS system of claim 1, wherein, the voltages of the first and second pins are set to a connecting voltage by the UFS host and UFS device in a reset operation of the UFS system,
wherein the UFS host and the UFS device are configured to select, based on the connecting voltage, one of the HS-LSS and a low speed-link startup sequence (LS-LSS) as a link startup mode, and
wherein the first and second UIC layers are configured to initiate an LSS operation based on the selected link startup mode.

3. The UFS system of claim 2,
wherein the UFS host comprises:
a first link startup mode configuring circuit configured to control the voltage of the first pin based on the first information; and
a first link startup mode determining circuit configured to
compare the connecting voltage of the first pin with a reference voltage,
select one of the HS-LSS and the LS-LSS as the link startup mode based on the comparison, and
transmit a first signal corresponding to the selected link startup mode to the first UIC layer, and
wherein the UFS device includes:
a second link startup mode configuring circuit configured to control the voltage of the second pin based on the second information; and
a second link startup mode determining circuit configured to
compare the connecting voltage of the second pin with the reference voltage,
select one of the HS-LSS and the LS-LSS as the link startup mode based on the comparison, and
transmit a second signal corresponding to the selected link startup mode to the second UIC layer.

4. The UFS system of claim 3, wherein, in the reset operation of the UFS system, the UFS host is configured to transmit a reset signal to the UFS device,
wherein the first link startup mode configuring circuit of the UFS host is configured to drive, before the reset signal is set to a high level, the voltage of the first pin based on the first information,
wherein the second link startup mode configuring circuit of the UFS device is configured to drive, before the reset signal is set to the high level, the voltage of the second pin based on the second information, and
wherein each of the first and second link startup mode determining circuits is configured to select, based on a rising edge of the reset signal, the link startup mode based on the connecting voltage.

5. The UFS system of claim 3, wherein, in the reset operation of the UFS system, the UFS host is configured to transmit a reset signal to the UFS device,
wherein the first link startup mode configuring circuit of the UFS host is configured to drive, based on the reset signal being set to a high level, the voltage of the first pin based on the first information,
wherein the second link startup mode configuring circuit of the UFS device is configured to drive, based on the reset signal being set to the high level, the voltage of the second pin based on the second information, and
wherein each of the first and second link startup mode determining circuits is configured to select, based on a mode check signal, the link startup mode based on the connecting voltage.

6. The UFS system of claim 3,
wherein the first link startup mode configuring circuit comprises:
a first pull-up driver connected between a power supply voltage and the first pin; and
a first pull-down driver connected between the first pin and a ground voltage, and
wherein the second link startup mode configuring circuit comprises:
a second pull-up driver connected between the power supply voltage and the second pin; and
a second pull-down driver connected between the second pin and the ground voltage.

7. The UFS system of claim 6, wherein a driving strength of the first and second pull-down drivers is larger than a driving strength of the first and second pull-up drivers.

8. The UFS system of claim 6, wherein the power supply voltage is a power supply voltage (VCCQ) in a range of 1.14 V to 1.26 V.

9. The UFS system of claim 6, wherein, based on both the UFS host and the UFS device supporting the HS-LSS, the connecting voltage is set to the power supply voltage that is greater than the reference voltage,
wherein, based on both the UFS host and the UFS device not supporting the HS-LSS, the connecting voltage is set to the ground voltage, and
wherein, based on one of the UFS host and the UFS device not supporting the HS-LSS, the connecting voltage is set to a first voltage that is smaller than the reference voltage and greater than the ground voltage.

10. The UFS system of claim 1, wherein the UFS host comprises
a UFS host controller configured to transmit a UFS protocol information unit (UPIU) to the UFS device through the first UIC layer, and
wherein the UFS device comprises:
a nonvolatile memory; and
a UFS device controller configured to control the nonvolatile memory based on the UPIU received through the second UIC layer.

11. The UFS system of claim 1, wherein each of the first and second UIC layers includes an MIPI Unipro and an MIPI M-PHY.

12. An operation method of a universal flash storage (UFS) system including a UFS host and a UFS device, the method comprising:
in a reset operation of the UFS system, driving, by the UFS host, a voltage of a first pin based on first information and driving, by the UFS device, a voltage of a second pin based on second information, the second pin being electrically connected to the first pin;
determining, by each of the UFS host and the UFS device, a link startup mode based on a connecting voltage of the first and second pins; and
performing, based on the determined link startup mode, a link startup sequence (LSS) operation on a first UFS interconnect (UIC) layer of the UFS host and a second UIC layer of the UFS device,
wherein the first information indicates that a high speed-LSS (HS-LSS) is supported by the UFS host or that the HS-LSS is not supported by the UFS host, and
wherein the second information indicates that the HS-LSS is supported by the UFS device or that the HS-LSS is not supported by the UFS device.

13. The method of claim 12, wherein driving the voltage of the first pin based on the first information and driving the voltage of the second pin based on the second information comprises:
driving, by the UFS host and based on the UFS host supporting the HS-LSS, the first pin with a power supply voltage, or driving, by the UFS host and based on the UFS host not supporting the HS-LSS, the first pin with a ground voltage; and
driving, by the UFS device and based on the UFS device supporting the HS-LSS, the second pin with the power supply voltage, or driving, by the UFS device and based on the UFS device not supporting the HS-LSS, the second pin with the ground voltage.

14. The method of claim 13, wherein, based on both the UFS host and the UFS device supporting the HS-LSS, the connecting voltage of the first and second pins is set to the power supply voltage,
wherein, based on both the UFS host and the UFS device not supporting the HS-LSS, the connecting voltage of the first and second pins is set to the ground voltage, and
wherein, based on one of the UFS host and the UFS device not supporting the HS-LSS, the connecting voltage of the first and second pins is set to a first voltage that is smaller than the power supply voltage and greater than the ground voltage.

15. The method of claim 14, wherein when the connecting voltage of the first and second pins is the power supply voltage, the link startup sequence operation on the first UIC layer of the UFS host and the second UIC layer of the UFS device is performed based on the HS-LSS, and
when the connecting voltage of the first and second pins is the ground voltage or the first voltage, the link startup sequence operation on the first UIC layer of the UFS host and the second UIC layer of the UFS device is performed based on a low speed-LSS (LS-LSS).

16. The method of claim 12, comprising:
transmitting, by the UFS host, a reset signal to the UFS device,
wherein driving the voltage of the first pin based on the first information and driving the voltage of the second pin based on the second information are performed before the reset signal is set to a high level.

17. The method of claim 12, comprising:
after the link startup sequence operation is performed, performing, by the UFS host and the UFS device, UFS transport protocol (UTP) layer initialization, UFS application (UAP) layer initialization, and device initialization completion.

18. A universal flash storage (UFS) device comprising:
a UFS interconnect (UIC) layer configured to communicate with an external UFS host;
a nonvolatile memory;
a UFS device controller configured to control the nonvolatile memory based on a command received from the UIC layer; and
a link startup mode circuit configured to drive a first pin with a power supply voltage based on a high speed-link startup sequence (HS-LSS) for the UIC layer being supported and to drive the first pin with a ground voltage based on the HS-LSS for the UIC layer being not supported,
wherein the first pin is electrically connected to the external UFS host,
wherein, in a reset operation of the UFS device, the link startup mode circuit is configured to select, based on a voltage of the first pin, one of the HS-LSS and a low speed-LSS (LS-LSS) as a link startup mode, and
wherein the UIC layer is configured to perform a link startup sequence operation with the external UFS host based on the selected link startup mode.

19. The UFS device of claim 18, wherein the link startup mode circuit includes:
a link startup mode configuring circuit configured to drive the first pin with the power supply voltage or the ground voltage; and
a link startup mode determining circuit configured to select, based on the voltage of the first pin, one of the HS-LSS and the LS-LSS.

20. The UFS device of claim 19, wherein, in the reset operation of the UFS device, the UFS device is configured to receive a reset signal from the external UFS host,
wherein the link startup mode configuring circuit is configured to drive, before the reset signal is set to a high level, the first pin with the power supply voltage or the ground voltage, and
wherein the link startup mode determining circuit is configured to select, based on a rising edge of the reset signal, one of the HS-LSS and the LS-LSS based on the voltage of the first pin.

21-26. (canceled)
